(19) United States
(12) Patent Application Publication
(10) Pub. No.: US 2026/0288705 A1
(43) Pub. Date: Sep. 24, 2026

(54) SYSTEM

(71) Applicant: SoftBank Group Corp., Tokyo (JP)

(72) Inventor: Akitomo MITSUI, Tokyo (JP)

(73) Assignee: SoftBank Group Corp., Tokyo (JP)

(21) Appl. No.: 19/565,575

(22) Filed: Mar. 13, 2026

(30) Foreign Application Priority Data
Mar. 19, 2025 (JP) 2025-045010

(51) Int. Cl. G06F 16/242; G06F 16/2452; G06F 16/248

(52) U.S. Cl. CPC G06F 16/243; G06F 16/2425; G06F 16/24522; G06F 16/248

(57) ABSTRACT

A system includes a processor that is configured to analyze a table structure of a data storage device and learn the table structure, receive an information request from a user in natural language or in a specific format and generate a prompt sentence for instructing a generative AI model to generate a query language, and automatically generate the query language based on the analyzed prompt and obtain information from the data storage device.

### CROSS-REFERENCE TO RELATED APPLICATION

This application is based on and claims priority under 35 USC 119 from Japanese Patent Application No. 2025-045010 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional data retrieval systems that access data storage devices, such as databases or data warehouses, generally require users to manually construct query statements in a query language, for example SQL. In such systems, even when schema information is available in the data storage device, users must understand table structures, column definitions, and relationships between tables to accurately formulate queries. As a result, non-technical users or users unfamiliar with complex table structures face a high barrier to retrieving desired information. Moreover, existing natural language interface systems often rely on fixed rules or templates and do not effectively utilize detailed table structure information or generative AI models, so they may fail to generate appropriate query statements for varied and complex user information requests. There is therefore a need for a system that can automatically analyze and learn the table structure of a data storage device, accept user information requests in natural language or in a specific format, and reliably generate suitable query language statements using a generative AI model, thereby enabling accurate and efficient information retrieval without requiring specialized knowledge of the underlying data schema or query language syntax.

### SUMMARY

To solve the above-described problem, an embodiment provides a system comprising a processor, wherein the processor is configured to analyze a table structure of a data storage device and learn the table structure. By analyzing metadata, such as table definitions, column definitions, keys, and relationships, the processor builds an internal representation of the schema and, in some embodiments, selectively analyzes and learns all or part of the table structure according to a target domain or application. The processor is further configured to receive an information request from a user in natural language or in a specific format and to generate a prompt sentence for instructing a generative AI model to generate a query language. In particular, the processor analyzes the content of the information request, extracts intent elements such as requested measures, conditions, and target entities, and encodes these elements into a structured prompt sentence that guides the generative AI model. The processor then automatically generates the query language based on the analyzed prompt, for example by providing the prompt to the generative AI model and obtaining a query language statement that reflects the learned table structure. Using the generated query language, the processor issues a query to the data storage device and obtains the requested information. In this manner, the system enables automatic and accurate generation of query language statements, while hiding the complexity of table structures and query syntax from the user.

The term “system” refers to a combination of hardware and software components including at least one processor and, optionally, one or more memory devices, network interfaces, and storage devices configured to execute the processing described in the claims.

The term “processor” refers to any hardware component or combination of components capable of executing instructions, including but not limited to a central processing unit (CPU), a graphics processing unit (GPU), a digital signal processor (DSP), a microcontroller, an application-specific integrated circuit (ASIC), a field-programmable gate array (FPGA), or a plurality of such components.

The term “data storage device” refers to any device or system that stores structured data accessible by a query language, including but not limited to a relational database, a data warehouse, a distributed database system, a cloud-based storage service with structured data interfaces, or a combination thereof.

The term “table structure” refers to schema information of the data storage device defining tables and their organization, including table names, column names, data types, keys, indexes, and relationships such as primary keys and foreign keys between tables.

The term “analyze a table structure” refers to reading, interpreting, and extracting schema information from the data storage device, including identifying tables, columns, keys, and relationships between tables, by using metadata catalogs, system tables, configuration files, or equivalent mechanisms.

The term “learn the table structure” refers to building and maintaining an internal representation or model of the analyzed table structure, such that the processor can subsequently use the representation or model to generate query language statements and determine relationships between data elements.

The term “information request” refers to any expression of a user's desire to retrieve, aggregate, filter, or otherwise obtain data from the data storage device, including questions, commands, or parameterized requests.

The term “user” refers to a human operator or an external system acting on behalf of the human operator that provides the information request to the system and receives the information obtained from the data storage device.

The term “natural language” refers to a human language, such as English, Japanese, or any other spoken or written language, in which the user expresses the information request in free-text form.

The term “specific format” refers to a predefined non-natural language format in which the information request is expressed, such as a structured form input, a parameterized template, a markup language, or a machine-readable data structure including, for example, JSON or XML.

The term “prompt sentence” refers to a text or token sequence generated by the processor that instructs or guides a generative AI model to produce a query language statement by describing the user's information request and relevant schema context.

The term “generative AI model” refers to a machine learning model capable of generating output text or tokens, including query language statements, in response to a prompt, and may include, for example, a large language model or any neural network-based generative model trained on text or code.

The term “query language” refers to any language used to request data from the data storage device, including but not limited to SQL, variants of SQL, or other declarative or procedural query languages.

The term “automatically generate the query language” refers to producing a query language statement by the processor without requiring the user to manually write the query language, based at least on the information request and the prompt sentence and optionally using output from the generative AI model.

The term “obtain information from the data storage device” refers to executing a generated query language statement against the data storage device and receiving a result set or response that includes data matching the user's information request.

The term “selectively analyze and learn all or part of the table structure” refers to analyzing and learning only a subset or the entirety of the table structure, based on criteria such as table names, schemas, domains, or usage patterns, so that the processor can focus on relevant portions of the data storage device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

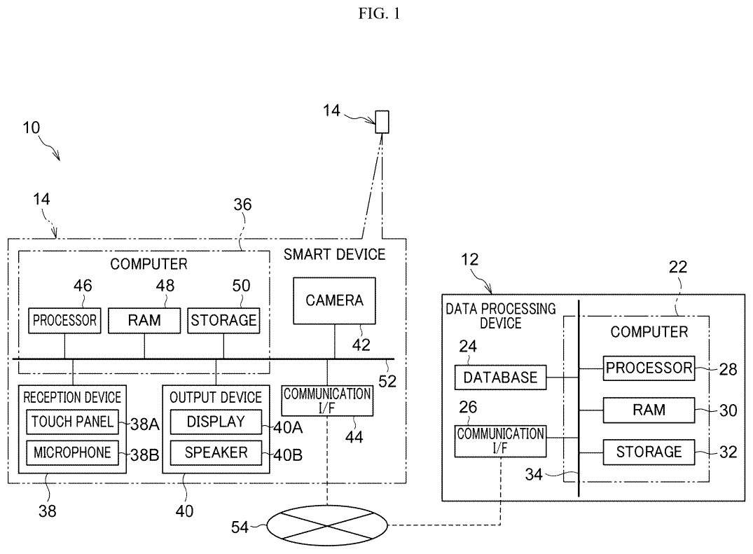

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

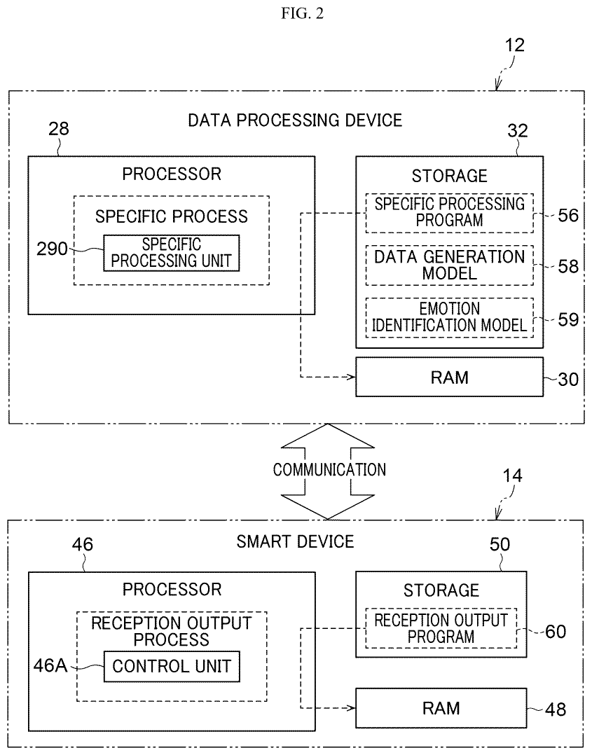

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional data retrieval systems that access structured information stored in storage apparatuses generally require an operator to manually design and issue queries written in a formal query language. In many cases, a user must understand internal table structures, column names, and relationships between tables, and must possess expertise in query languages. As a result, the usability of such systems is limited to skilled users, and ordinary users are forced either to depend on specialists or to perform repeated trial-and-error operations. Furthermore, even when a generative artificial intelligence model is introduced to assist query generation, such assistance is often limited to a one-shot conversion from natural language to a query expression, without awareness of the actual data schema or safety constraints. This can lead to invalid queries, schema mismatches, or inefficient access paths, which ultimately degrade system performance and reliability.

From the perspective of computer technology, these limitations manifest as inefficient use of computing resources and storage bandwidth. When a generative artificial intelligence model generates a query that does not conform to an underlying schema, a database engine may perform unnecessary scans, fail with errors, or require expensive retries. Repeated query failures and manual corrections increase processor load, network traffic, and latency. Moreover, systems that do not incorporate schema-aware control into prompt generation for generative artificial intelligence models are unable to systematically constrain the search space of candidate queries, resulting in unstable execution times and unpredictable behavior.

Therefore, there is a need for a computer-implemented technique that automatically converts a natural-language information acquisition request from a user into a valid query formal language expression, while taking into account an actual structure of structured information. Such a technique should control the behavior of a generative artificial intelligence model by providing schema-aware prompt sentences, validate and, if necessary, automatically correct generated queries, and iteratively process user requests without requiring explicit knowledge of schema details or query syntax. By tightly coupling schema analysis, prompt generation, generative artificial intelligence inference, and query execution, the technique should improve the overall efficiency, robustness, and responsiveness of a data retrieval system as a whole.

The specific processing by the specific processing unit 290 of the data processing device 12 in Example 1 is realized by the following means.

The present invention provides a server comprising a processor configured to acquire attribute information related to a structure of structured information stored in an information processing apparatus, analyze a logical structure and relationships between items of the structured information based on the attribute information, and store an analysis result as a learning result; to receive, in a natural language format via a communication line from a terminal device, an information acquisition request of a user and extract an intention and a condition of the information acquisition request; to generate, based on the learning result and the extracted intention and condition, a schema-aware prompt sentence to be input to a generative artificial intelligence model and to instruct the generative artificial intelligence model to generate a query formal language using the prompt sentence; to obtain the query formal language output from the generative artificial intelligence model, inspect whether a referenced information structure and item name in the query formal language conform to the structure of the structured information, and, when the query formal language is nonconforming, automatically correct the query formal language by modifying the prompt sentence and instructing the generative artificial intelligence model to regenerate the query formal language; and to execute a query process on the information processing apparatus by using the corrected query formal language, process information acquired by the query process into output information by aggregation processing or formatting processing, and transmit the output information to the terminal device. This enables the server to systematically constrain and guide the operation of the generative artificial intelligence model with respect to an actual data schema, thereby reducing invalid or inefficient queries, improving the stability and performance of query execution, and allowing a user to obtain desired information through natural-language interaction without requiring expertise in query languages or data structures.

The term “processor” refers to a hardware-implemented arithmetic and logic unit, a central processing unit, or a computational circuitry including one or more processing cores that execute instructions to perform the functions described in the present disclosure.

The term “system” refers to a combination of at least one processor and one or more associated components, including memory, communication interfaces, and storage, that cooperate to execute the processing described in the present disclosure.

The term “information processing apparatus” refers to an apparatus including at least one processor and a storage medium, the apparatus being configured to store structured information and to execute query processing on the structured information.

The term “structured information” refers to information stored in a predetermined schema, such as records arranged in one or more logical tables, each table including items represented as fields or columns with defined data types and relationships.

The term “attribute information” refers to metadata describing a structure of the structured information, including but not limited to table names, item names, data types, key relationships, and constraints defined for the structured information.

The term “logical structure” refers to an arrangement of items and groups of items in the structured information, including table-level organization, field composition, key definitions, and relationships between tables such as associations and joins.

The term “relationship between items” refers to an association, dependency, or linkage defined or inferred between two or more items of the structured information, such as foreign key relations, hierarchical relations, or common key-based join relations.

The term “learning result” refers to data representing an internal model, mapping, or summary that the processor maintains after analyzing the attribute information, the logical structure, and the relationships between items of the structured information.

The term “terminal device” refers to a user-operated electronic apparatus, such as a client device including a display, an input interface, and a communication interface, that transmits information acquisition requests and receives output information through a communication network.

The term “user” refers to any person or entity that issues an information acquisition request via the terminal device, regardless of technical expertise in query languages or database schemas.

The term “information acquisition request” refers to a request expressing a need to obtain, aggregate, filter, or otherwise process structured information, the request being formulated in a natural language or other human-readable form.

The term “natural language format” refers to a textual representation of a request or instruction expressed in a human language, such as a sentence or phrase that is not directly written in a formal query language.

The term “intention” refers to a semantic objective of the information acquisition request, including a target dataset, an operation type such as retrieval or aggregation, and a desired output form.

The term “condition” refers to a constraint, filter, grouping criterion, sorting requirement, or range specification included in or implied by the information acquisition request.

The term “generative artificial intelligence model” refers to a machine-learned model that receives input data, such as a prompt sentence, and generates output data, such as a query formal language expression, based on learned statistical patterns.

The term “prompt sentence” refers to a structured input sequence provided to the generative artificial intelligence model, the input sequence including at least part of the attribute information, schema-related instructions, and the information acquisition request.

The term “schema-aware prompt sentence” refers to a prompt sentence that includes attribute information representing at least part of the structure of the structured information, thereby constraining the generative artificial intelligence model to generate outputs consistent with the schema.

The term “query formal language” refers to a machine-interpretable language expression, such as a structured query language statement, that specifies operations for retrieving or processing structured information stored in the information processing apparatus.

The term “referenced information structure” refers to a part of the structured information that a query formal language expression designates for access, including table identifiers, item identifiers, and relationship specifications.

The term “item name” refers to an identifier of a field, column, or attribute in the structured information that the query formal language uses to specify data to be retrieved or processed.

The term “nonconforming” refers to a state in which a query formal language expression references an information structure, item name, or operation that is inconsistent with or not defined by the structure of the structured information.

The term “automatically correct” refers to a process in which the processor, without requiring user intervention, modifies the prompt sentence and requests the generative artificial intelligence model to regenerate a query formal language so as to conform to the structure of the structured information.

The term “query process” refers to an execution procedure in which the information processing apparatus interprets and executes a query formal language expression to retrieve, filter, aggregate, or otherwise operate on the structured information.

The term “aggregation processing” refers to a computation applied to multiple records or items, such as summation, counting, averaging, maximum, minimum, grouping, or other statistical combination of values.

The term “formatting processing” refers to a transformation of retrieved information into a predetermined representation, such as reordering fields, converting data types, labeling output fields, or adapting the information to a display format.

The term “output information” refers to information generated as a result of the query process and subsequent aggregation processing or formatting processing, the information being suitable for presentation to the user.

The term “visualize” refers to a process in which a terminal device displays output information in a human-perceivable form, such as a table, chart, list, or graphical representation.

The term “tabular format” refers to a two-dimensional layout in which output information is arranged in rows and columns, each column corresponding to an item and each row corresponding to a record.

The term “chart format” refers to a graphical representation, such as a bar graph, line graph, pie chart, or similar visual element, that illustrates output information using geometric shapes and axes.

The term “additional information acquisition request” refers to a subsequent natural-language request provided by the user after initial output information is presented, the request refining, extending, or narrowing a prior information acquisition request.

The term “information range” refers to a subset of the structured information, such as a particular table, a group of items, a specific time interval, or a specific category, that is targeted by a query formal language expression.

The term “communication line” refers to any wired or wireless communication path, including a local network or a wide-area network, over which data is transmitted between the terminal device and the server.

In one embodiment, a server cooperates with at least one terminal and at least one user to implement a system that converts natural-language information acquisition requests into query formal language expressions and executes those expressions against structured information stored in an information processing apparatus.

The server comprises at least one processor, at least one main memory, a nonvolatile storage device, and a communication interface. The server executes system software such as an operating system and application software including a schema analysis module, a prompt generation module, a generative AI client module, a query validation module, a query execution module, and a response formatting module. The server is communicatively coupled, via a network, to an information processing apparatus that implements a database management function, and to at least one terminal.

The information processing apparatus stores structured information in one or more logical tables. Each table includes items such as fields or columns, with associated data types, keys, and constraints. The information processing apparatus may be implemented by a relational database management system executing on a generic computing platform. The information processing apparatus exposes an interface, such as a query interface accepting structured query language statements, through which the server can submit queries and receive result sets.

The terminal comprises a processor, a display, an input device, and a communication interface. The terminal executes client software such as a browser application or a dedicated client application. The terminal displays an input field and a result view on the display, and sends user-entered information acquisition requests, expressed in a natural language, to the server via the communication interface. The terminal receives output information from the server and renders the information on the display in a tabular format or a chart format.

The user operates the terminal to enter information acquisition requests in a natural-language format. The user is not required to have knowledge of the schema of the structured information or of any query formal language. The user can iteratively refine the requests by entering additional natural-language sentences after viewing the output information presented on the terminal.

The server analyzes attribute information describing a structure of the structured information. The server acquires attribute information such as table names, item names, data types, primary key definitions, foreign key definitions, and indexing information from a schema storage of the information processing apparatus. The server stores this attribute information in a schema metadata store in main memory or nonvolatile storage. The server uses this schema metadata to construct a logical structure graph in which nodes represent tables or items and edges represent relationships such as key-based joinability or referential constraints.

The server implements a schema analysis module that constructs the logical structure graph and maintains a mapping between user-oriented semantic concepts and internal item names. The server may maintain, for each item, statistical descriptors such as value distributions, cardinality estimates, and co-occurrence frequencies with other items. The server uses these descriptors as features for subsequent AI-based inference.

The server includes a generative AI client module that interfaces with a generative AI model. The generative AI model is implemented as a neural network with a sequence-to-sequence architecture, for example a transformer architecture having an encoder and a decoder with multiple self-attention layers. The generative AI model is trained in advance on pairs of prompt sentences and target query expressions. During operation of the system, the generative AI model executes in an inference mode on a computing resource that may include one or more graphical processing units or other hardware accelerators.

The server uses internal features when interacting with the generative AI model. The server encodes the schema metadata into textual segments such as table descriptions and item descriptions. For example, the server may generate textual summaries like “Table: sales_table, Columns: year (integer), month (integer), product_category (string), sales_amount (numeric).” The server concatenates such schema-related text with the user's natural-language request and a task description into a prompt sentence.

In one example, the server generates a prompt sentence as follows:

“Database schema:

Table: sales_table

Columns: year (INT), month (INT), product_category (STRING), sales_amount (NUMERIC)

User request:

‘I want to know the monthly sales for 2023 by product category.’

Task:

Generate a valid SQL query that answers the user request using the above schema. Output only the SQL statement.”

In another example, the server generates a prompt sentence as follows:

“Database schema:

Table: sales_table

Columns: year (INT), month (INT), product_category (STRING), sales_amount (NUMERIC)

User request:

‘I want to aggregate the sales data by product category.’

Task:

Return a valid SQL query that aggregates the total sales per product category using the above schema. Output only the SQL statement.”

In still another example, the server generates a prompt sentence as follows:

“Database schema:

Table: sales_table

Columns: year (INT), month (INT), product_category (STRING), sales_amount (NUMERIC)

User request:

‘Show the top 5 product categories by total sales in 2023.’

Task:

Generate a valid SQL query that sums sales_amount for year 2023 per product category, orders by the total in descending order, and returns only the top 5 rows. Output only the SQL statement.”

The server constructs such prompt sentences in a schema-aware manner. The server selects attribute information corresponding to all or a part of the structure of the structured information that is relevant to the user's request. For example, the server can restrict the prompt sentence to one table or to items linked by a particular foreign key relationship, thereby narrowing the potential output space of the generative AI model. By limiting the schema context in the prompt sentence, the server reduces ambiguity and helps the generative AI model converge to valid query expressions that are consistent with the actual schema.

The server uses a generative AI model that performs token-level probability computations over a vocabulary. The generative AI model receives the prompt sentence as an input sequence of tokens. The generative AI model produces, for each position of the output sequence, a probability distribution over candidate tokens representing parts of a query expression. The decoder of the generative AI model uses self-attention to consider previously generated tokens and encoder-decoder attention to consider the input prompt tokens. The generative AI model then selects tokens with highest probabilities or samples tokens under predetermined decoding strategies and generates an output string representing a candidate query formal language, such as a structured query language statement.

The server's generative AI client module configures parameters of the generative AI model, such as maximum output length, temperature, and beam width in beam search decoding. The server selects parameter values to reduce randomness and to favor syntactically consistent query expressions. For example, the server may use a low temperature and a small beam width to reduce the number of alternative outputs, which improves determinism and reduces the need for repeated validation passes.

The server receives the candidate query expression from the generative AI model and passes it to a query validation module. The query validation module parses the expression into an internal representation, such as an abstract syntax tree. The query validation module compares item names and table names appearing in the abstract syntax tree with item names and table names stored in the schema metadata store. The query validation module rejects query expressions that reference nonexistent items or tables, or that request operations that are not permitted under a predefined safety policy, such as modification transactions.

The server implements specific rules that differ from manual human query composition and from generic AI usage. The query validation module enforces a nonconventional pipeline in which the generative AI model acts as a constrained proposal generator, and the server acts as a gatekeeper that automatically reformulates the prompt sentence when the proposal does not conform to the schema. For instance, when the query validation module detects an item name that is not present in the schema, the server rewrites the prompt sentence as follows:

“The previous SQL was invalid because column ‘sales’ does not exist. The correct columns are: year, month, product_category, sales_amount. Generate a corrected SQL query that uses only existing columns.”

The server then resubmits the modified prompt sentence to the generative AI model. This closed-loop control, in which validation feedback is encoded into the next prompt sentence, causes the generative AI model to converge to a schema-conforming expression without human intervention. This differs from ordinary manual trial-and-error in which a human operator inspects and corrects invalid SQL. By embedding validation feedback into prompt sentences, the server implements a technical mechanism that reshapes the input space for the generative AI model in a structured, repeatable way.

The server exploits this loop to improve computational efficiency. Because the server includes only relevant schema fragments in the prompt sentence and because the server automatically constrains the generative AI model through repeated schema-specific feedback, the search space of candidate queries is reduced. This leads to fewer invalid queries and fewer execution failures on the information processing apparatus. As a result, the processor load on the information processing apparatus is reduced, the number of full table scans due to schema mismatches is minimized, and the total data transferred over the communication interface between the server and the information processing apparatus is reduced. Query latency is improved because successful query execution is reached with fewer retries and because generated queries tend to use correct keys and indexing paths.

The server can further improve processing efficiency by using index-aware hints in the prompt sentences. For example, the server may add text such as “Use the ‘year’ column as a filter condition and the ‘product_category’ column as a grouping key” when such columns are known to be indexed. In response, the generative AI model is more likely to generate query expressions that align with index usage, resulting in reduced I/O cost and improved query execution time at the information processing apparatus.

The server uses a specific training and execution regime for the generative AI model. In one embodiment, the generative AI model is pre-trained on generic language corpora and then fine-tuned on domain-specific pairs of (prompt sentence, query expression). During fine-tuning, the server or an offline training system computes a loss function, for example a cross-entropy loss between predicted token distributions and ground-truth query tokens. A gradient-based optimization algorithm, such as stochastic gradient descent with momentum or adaptive optimization, updates the weights of the neural network. The model is trained to reduce errors in token prediction under prompt sentences that include schema descriptions and user requests. Inference-time performance is thus enhanced for the specific schema-aware prompting style used by the server.

The server uses a data flow that is explicit and technically grounded. Schema metadata flows from the information processing apparatus to the schema analysis module, then to the prompt generation module as part of attribute information. User requests flow from the terminal to the prompt generation module, which combines them with attribute information. Prompt sentences flow from the prompt generation module to the generative AI client module, then to the generative AI model. Candidate query expressions flow back to the query validation module, then to the query execution module. Result sets flow from the information processing apparatus to the response formatting module, then to the terminal. Each module performs specific computations that transform data representations in a defined manner, thereby improving internal efficiency of the computing system.

The server distinguishes this method from a simple automation of human tasks by exploiting internal data structures and control flows that are not available to a human user. The server uses a logical structure graph, index usage statistics, validation feedback encoding into prompt sentences, and a closed-loop generation-and-validation cycle that operates at machine speed. This cycle allows the server to explore multiple candidate query expressions with fine-grained control over model parameters and schema context, something that would be impractical or impossible for a human operator to reproduce manually at comparable speed and scale.

The server processes the result sets obtained from the information processing apparatus. The response formatting module converts the result sets into output information with a predetermined structure suitable for display. The server may transform column names into user-oriented labels, compute derived metrics such as percentages, and re-encode categorical values into more interpretable representations. The server can compress response data before transmission to the terminal to reduce network load. These post-processing operations result in a representation of data that is both machine efficient and human interpretable.

The terminal displays the output information in a structured manner. The terminal may present a table listing items such as product category, month, and total sales, aligned in columns. The terminal may generate charts such as bar charts or line charts. The terminal reads parameters included in the response, such as labels, units, and preferred chart types, and configures visualization components accordingly. The terminal thus supports interactive data exploration driven by natural-language input.

The user, after reviewing the displayed output information, can issue an additional information acquisition request. For example, the user may input, “Now show only the top 5 product categories by total sales in 2023.” The terminal transmits this additional request to the server. The server reuses the schema metadata and the previously constructed logical structure graph.

The server generates a new prompt sentence, for example:

“Database schema:

Table: sales_table

Columns: Year (int), Month (int), Product_category (string), Sales_amount (numeric)

User request:

‘Now show only the top 5 product categories by total sales in 2023.’

Task:

Generate a valid SQL query that sums sales_amount for year 2023 per product category, orders the categories by total sales in descending order, and returns only the top 5 rows. Output only the SQL statement.”

The server sends this prompt sentence to the generative AI model, obtains a candidate query expression, validates it using the schema metadata, and executes it on the information processing apparatus. The server then formats the output information and returns it to the terminal. In this manner, the system implements an iterative information acquisition process without requiring the user to manually write or adjust query expressions.

The server achieves technical effects beyond mere automation of human reasoning. By incorporating schema-aware prompt generation, structural validation, and closed-loop regeneration, the server reduces the number of invalid queries, lowers the average computational cost per successful query, and provides more predictable query latency. Because the server modifies the prompt sentences based on precise schema diagnostics and policy checks, the generative AI model is systematically guided to conform to a constrained output space tailored to the current data environment. This leads to higher accuracy in the mapping from natural-language requests to executable query formal language expressions and thus reduces errors arising from misinterpretation of user intent or schema structure.

The server can implement variations of the embodiment. In one variation, the server runs the generative AI model locally on dedicated hardware. In another variation, the server accesses the generative AI model as a remote service over a network. In yet another variation, different generative AI models are used for different schemas or domains, and the server selects an appropriate model configuration based on the attribute information of the target structured information. In still another variation, the server uses additional modules that pre-classify user requests into categories, such as aggregation, filtering, or ranking, and adjusts the prompt sentence accordingly to reduce ambiguity in the generative AI model's task.

The terminal can be implemented as a mobile device, a desktop computer, or an embedded device. Different visualization libraries or graphical frameworks may be used to render output information. The modality of user input may include keyboard input, voice input converted into text, or other interfaces. However, in all cases, the terminal transmits the user's information acquisition requests in a natural-language format to the server and displays the output information received from the server.

The information processing apparatus may store structured information of different domains, such as sales records, sensor readings, or manufacturing logs. The server does not assume a specific business workflow; instead, the server is designed to interact with the schema structures and query interfaces provided by the information processing apparatus. The same technical architecture can therefore be applied to various domains where structured information is stored in table-like formats and where users wish to query the data using natural-language expressions. Through these embodiments, the server improves computer technology itself by optimizing the interplay between schema metadata, generative AI inference, and query execution. The system reduces computational waste, improves the precision of natural-language-to-query translation, and provides a scalable mechanism for schema-aware control of generative AI models. As a result, the system offers technical benefits such as faster query response times, reduced error rates, and more efficient management of processing and communication resources across the server, the terminal, and the information processing apparatus.

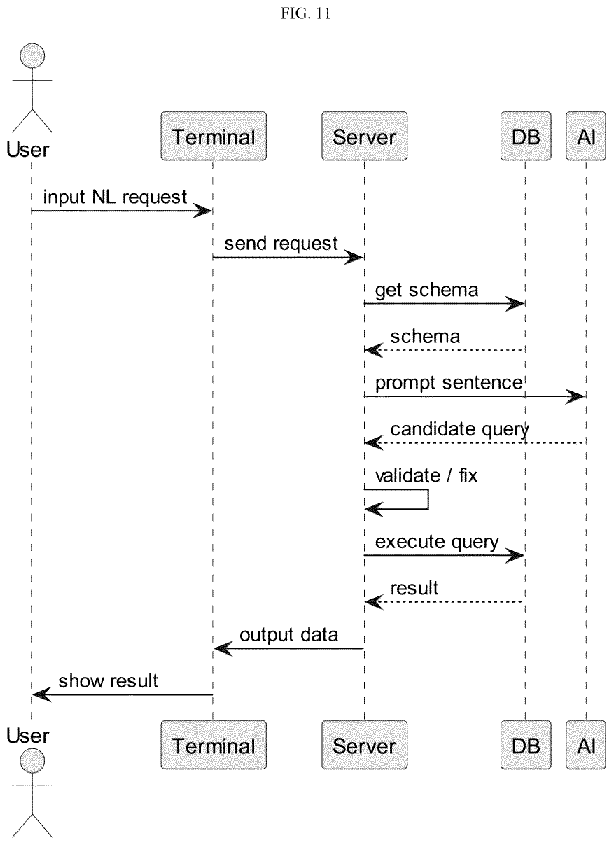

The following describes the processing flow using FIG. 11.

### Step 1

The user operates the terminal to input an information acquisition request in a natural language. The terminal receives, as input, a text string such as “I want to know the monthly sales for 2023 by product category.” The terminal performs input validation to confirm that the string is non-empty and encodes the text into a request message including a user identifier and a timestamp. Based on this input, the terminal formats the text into a structured payload and outputs the payload to the server via a communication interface using a network protocol.

### Step 2

The server receives the request payload from the terminal and performs initial parsing and logging.

The server obtains, as input, the structured payload containing the natural-language request text and metadata. The server parses the payload to extract the text of the information acquisition request, the user identifier, and the timestamp. The server writes these values into a log storage and a request context structure in memory. Based on this input, the server outputs a normalized representation of the user request, including fields such as “raw_text,” “user_id,” and “session_id,” for use in subsequent processing.

### Step 3

The server retrieves schema attribute information from the information processing apparatus. The server receives, as input, the normalized request context and a reference to the target data source. The server issues metadata queries to the information processing apparatus, such as system catalog queries, to obtain table names, item names, data types, and key relationships. The server aggregates the returned metadata into an internal schema metadata object. Based on this input, the server outputs a structured set of attribute information, including table descriptors and item descriptors, as a schema representation in memory.

### Step 4

The server constructs a logical structure representation and prepares schema features.

The server receives, as input, the schema metadata object. The server builds a logical structure graph in which nodes represent tables and items, and edges represent relationships such as foreign key links and join paths. The server computes additional features, such as frequency statistics or key cardinalities, by querying system statistics in the information processing apparatus. Based on this input, the server outputs an enriched schema representation that includes the logical structure graph and associated feature values.

### Step 5

The server analyzes the user's natural-language request to extract intention and conditions. The server receives, as input, the raw natural-language text and the enriched schema representation. The server applies a natural-language analysis routine, which may include tokenization, part-of-speech tagging, and pattern matching, to detect candidate entities such as years, categories, and aggregation terms. The server correlates detected terms with item names and schema features, for example mapping “2023” to a “year” item and “product category” to a “product_category” item. Based on this input, the server outputs an interpreted request structure that includes an operation type (e.g., aggregation), target items, filter conditions, and grouping keys.

### Step 6

The server generates a schema-aware prompt sentence for the generative AI model.

The server receives, as input, the enriched schema representation and the interpreted request structure. The server selects relevant tables and items from the schema, such as a “sales_table” and its columns, and formats them into a textual schema description. The server then embeds the user's original request text and a task description into a coherent prompt sentence. For example, the server may construct:

“database Schema:

Table: sales_table

Columns: year (INT), month (INT), product_category (STRING), sales_amount (NUMERIC)

User request:

‘I want to know the monthly sales for 2023 by product category.’

Task:

Generate a valid SQL query that answers the user request using the above schema. Output only the SQL statement.”

Based on the interpreted request and schema, the server outputs a completed prompt sentence prepared for the generative AI model.

### Step 7

The server transmits the prompt sentence to the generative AI model and configures inference parameters.

The server receives, as input, the prompt sentence and configuration information for inference, including maximum token length and decoding strategy. The server encodes the prompt text into tokens compatible with the generative AI model and sets parameters such as temperature and beam width to control determinism. The server sends the tokenized prompt and parameter settings to the generative AI model's execution environment. Based on this input, the server outputs a model invocation request that causes the generative AI model to begin generating a candidate query expression.

### Step 8

The generative AI model, as invoked by the server, generates a candidate query formal language expression.

The server receives, as input, intermediate token probability distributions produced by the generative AI model for each output position. The generative AI model applies a transformer-based sequence-to-sequence computation: the encoder transforms prompt tokens into contextual embeddings, and the decoder uses self-attention and encoder-decoder attention to compute probability distributions over possible next tokens. The server, following the configured decoding strategy, selects tokens at each position and concatenates them into a text sequence representing a query expression. Based on the model outputs, the server outputs a candidate query formal language string, for example a structured query language statement.

### Step 9

The server validates the candidate query expression against the schema.

The server obtains, as input, the candidate query string and the enriched schema representation. The server parses the query into an internal abstract syntax tree, identifies referenced table names and item names, and compares them with those present in the schema metadata. The server also checks for disallowed operations such as data modification or schema changes. If all referenced elements exist and comply with safety rules, the server marks the query as valid. If mismatches or violations are detected, the server produces a diagnostics report describing missing items, incorrect names, or forbidden operations. Based on this input, the server outputs either a validation success status with the validated query or a validation failure status with diagnostics information.

### Step 10

The server reformulates the prompt sentence and requests regeneration when validation fails. The server receives, as input, the validation failure status and the diagnostics report. The server extracts error details, such as an item name that does not exist, and constructs an augmented prompt sentence that includes explicit correction instructions. For example, the server may generate:

“The previous SQL was invalid because column ‘sales'does not exist. The correct columns are: year, month, product_category, sales_amount. Generate a corrected SQL query that uses only existing columns.”

The server appends this corrective text to or integrates it into the original schema-aware prompt. Based on this input, the server outputs a revised prompt sentence and re-invokes the generative AI model as in the earlier step, thereby obtaining a second candidate query expression.

### Step 11

The server executes the validated query expression on the information processing apparatus. The server receives, as input, a validated and schema-conforming query formal language string. The server submits this query to the information processing apparatus via a database interface using a database driver. The information processing apparatus interprets the query, selects an execution plan using its optimizer, and performs data operations such as index lookups, table scans, joins, grouping, and aggregation. The information processing apparatus returns a result set of records that satisfy the query conditions. Based on this input, the server outputs a result set object in memory, which is a structured collection of rows and columns.

### Step 12

The server formats the result set into output information for the terminal.

The server obtains, as input, the result set and optional formatting parameters, such as preferred column order and display labels. The server performs data processing such as sorting, numeric formatting, and calculation of derived values (e.g., percentages or cumulative sums). The server converts internal data types into a representation suitable for transmission, associates each column with a human-readable label, and structures the information into a response payload. Based on this input, the server outputs output information organized for rendering at the terminal.

### Step 13

The server transmits the output information to the terminal.

The server receives, as input, the formatted output information and a reference to the user session. The server encapsulates the output information into a response message and applies any required compression or encoding. The server transmits the message over the network to the terminal using the communication protocol, and logs transmission metadata such as size and latency. Based on this input, the server outputs a network response that delivers the processed data to the terminal.

### Step 14

The terminal renders the received output information for the user.

The terminal obtains, as input, the response message containing the output information. The terminal decodes and parses the payload to reconstruct the table of records and any associated metadata such as labels and chart preferences. The terminal maps this data to user interface components, such as a tabular grid or a chart view, arranging columns and rows on the display and drawing any graphical elements. Based on this input, the terminal outputs a visual representation of the data on the display, thereby making the query results observable to the user.

### Step 15

The user inspects the displayed information and optionally issues an additional natural-language request.

The user sees, as input, the displayed table or chart on the terminal. The user interprets the information and may decide to refine or extend the query by entering another natural-language sentence, such as “Now show only the top 5 product categories by total sales in 2023.” The user manipulates the input interface of the terminal to provide this new text. Based on this input, the terminal outputs a new request payload to the server, and the server repeats the above-described processing steps using the new natural-language request and the same or updated schema metadata.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional data retrieval systems that rely on structured query languages require a user to understand database schemas, table relationships, and query syntax. Even when a natural language interface is provided, existing approaches typically perform a shallow mapping from keywords to predefined queries and do not adapt to complex or changing data structures. As a result, users without specialized technical knowledge are unable to efficiently obtain accurate information from large-scale data storage devices.

Further, many existing systems treat natural language understanding, query generation, and visualization as separate components that are manually integrated. Such loose coupling results in increased latency, inconsistent interpretation of user intent across components, and high engineering overhead to maintain mappings between natural language inputs and evolving database schemas. These systems therefore fail to fully exploit advances in generative AI models to improve the end-to-end efficiency and accuracy of data retrieval and presentation.

From a computer technology standpoint, known architectures do not provide a processor that internally represents a natural language information request as a rich intermediate representation aligned with a learned information structure of the data storage device, and then systematically transforms that representation into executable query commands and visualization data in an automated and optimized manner. In many cases, schema information is hard-coded, and changes in the underlying tables or attributes require manual modification of application logic, which degrades scalability and maintainability of the computer system.

Additionally, existing visualization pipelines frequently operate as a post-processing add-on, disconnected from the original semantic interpretation of the user's request. This disconnection can lead to inappropriate chart types, misleading aggregations, or inefficient data transfers, thereby limiting the usability and performance of the system as a whole. The lack of an integrated, model-driven pipeline also places a burden on the computing resources, because redundant transformations and non-optimal queries are generated, causing unnecessary processor load and increased response time.

Accordingly, there is a need for an improved computer-implemented system in which a processor can (i) learn and maintain an internal model of the information structure of a data storage device, (ii) process a natural language prompt sentence from a user into a structured intermediate representation using a generative AI model, (iii) automatically generate optimized query commands based on both the intermediate representation and the learned information structure, and (iv) generate visualization information directly from the acquired data in a form suitable for efficient transmission and intuitive analysis on a user information processing apparatus. Such a system should improve the functioning of the computer itself by reducing manual schema coupling, minimizing redundant processing, and enabling more efficient and accurate end-to-end information retrieval and visualization.

The specific processing by the specific processing unit 290 of the data processing device 12 in Application Example 1 is realized by the following means.

The present invention provides a server comprising a processor configured to analyze and learn an information structure of a data storage device including an attribute set and a relation set, to receive from a user information processing apparatus via a communication line a prompt sentence including an information request in natural language together with identification information and environment information, to preprocess the prompt sentence by performing character string normalization, phrase segmentation, and code sequence conversion to generate an input data sequence for a generative AI model, to execute inference processing on the input data sequence by using the generative AI model so as to generate an intermediate representation including at least a target data set, a condition set, a join set, an aggregation set, and a classification set, to automatically generate a query command set in a query language based on the intermediate representation and the learned information structure and to transmit the query command set to the data storage device to acquire information from the data storage device, to perform aggregation processing and formatting processing on the acquired information to generate a display data set, and to generate visualization information including graphical elements based on the display data set and to transmit the visualization information as image data or structured data to the user information processing apparatus. This enables an integrated, computer-implemented pipeline in which the server improves internal handling of natural language information requests by dynamically aligning a learned data storage structure with model-based intermediate representations, thereby automatically producing optimized query commands and visualization information, reducing processing overhead, increasing accuracy and responsiveness of data retrieval, and enhancing the overall functioning and usability of the computer system.

The term “data storage device” refers to a hardware and/or software subsystem that stores structured data over time and responds to query commands to read, and optionally write, data records, including but not limited to relational database systems, non-relational database systems, and associated storage media.

The term “information structure” refers to metadata describing how data is organized within the data storage device, including an attribute set, a relation set, and other schema-related information such as table definitions, key definitions, and relationships among data entities.

The term “attribute set” refers to a collection of data attributes, such as columns or fields, each attribute representing a type of data element stored in the data storage device.

The term “relation set” refers to a collection of logical or physical relationships among data entities or tables in the data storage device, including associations based on primary keys, foreign keys, and other linking conditions.

The term “user information processing apparatus” refers to a computing device operated by a user, such as a mobile terminal, personal computer, or other electronic apparatus, that transmits a prompt sentence to the server and receives visualization information.

The term “prompt sentence” refers to a sequence of characters expressing an information request in natural language or in a semi-structured format, which is input by a user and provided to the server as a basis for query generation by the generative AI model.

The term “identification information” refers to data used to identify a user, a session, a device, or an application context associated with a prompt sentence, such as a user identifier, session token, or device identifier.

The term “environment information” refers to contextual data associated with a prompt sentence, including but not limited to locale, time zone, language settings, and device-specific parameters that influence interpretation of the information request.

The term “preprocess the prompt sentence” refers to performing one or more operations on the raw prompt sentence, such as character string normalization, phrase segmentation, tokenization, and code sequence conversion, to generate an input representation suitable for processing by the generative AI model.

The term “code sequence conversion” refers to converting textual elements of the prompt sentence into a sequence of machine-readable codes, such as token identifiers or numerical vectors, according to a predefined vocabulary or encoding scheme.

The term “generative AI model” refers to a machine learning model configured to generate output data, such as a structured intermediate representation or query-related information, based on input data sequences, and including but not limited to sequence-to-sequence models, transformer models, and other neural network-based generative architectures.

The term “input data sequence” refers to an ordered sequence of encoded elements derived from a prompt sentence, such as token identifiers or feature vectors, that is supplied as input to the generative AI model.

The term “intermediate representation” refers to a machine-readable structure generated by the generative AI model that describes the semantics of an information request, including at least a target data set, a condition set, a join set, an aggregation set, and a classification set, and that serves as a basis for generating query commands.

The term “target data set” refers to a subset of data in the data storage device identified by the intermediate representation as relevant to satisfying the information request, including one or more tables, views, or logical data groups.

The term “condition set” refers to a collection of constraints or predicates, such as filter conditions, ranges, or comparison expressions, that specify which records from the target data set should be selected.

The term “join set” refers to a collection of join specifications describing how two or more data entities are combined based on related attributes, such as equality of key fields or other join conditions.

The term “aggregation set” refers to a collection of aggregation operations, such as sum, count, average, minimum, or maximum, that are to be applied to groups of data records as part of query execution.

The term “classification set” refers to a collection of grouping or categorization definitions specifying how data records are partitioned or grouped, for example by region, category, or time interval.

The term “query language” refers to a formal language used to request data from the data storage device, including but not limited to structured query languages and other declarative or procedural query notations.

The term “query command set” refers to one or more commands expressed in a query language that are generated automatically based on the intermediate representation and the information structure and that are executable by the data storage device to retrieve information.

The term “aggregation processing” refers to computational operations that combine multiple data records into summary values, such as totals, averages, counts, or other statistical measures.

The term “formatting processing” refers to operations that transform acquired data into a structured layout suitable for presentation or transmission, including ordering, labeling, unit conversion, and restructuring of data elements.

The term “display data set” refers to a structured collection of data values derived from the acquired information and adapted for presentation, including prepared labels, axes values, and series values used for visualization.

The term “visualization information” refers to data describing a graphical representation of the display data set, including information about graphical elements such as axes, bars, lines, points, colors, labels, legends, and chart types.

The term “graphical elements” refers to visual components used to construct a graphical representation, including shapes, lines, text, color regions, markers, and other visual primitives.

The term “image data” refers to digital data representing a visual image of the visualization information in a raster or vector format suitable for display on the user information processing apparatus.

The term “structured data” refers to data organized according to a defined schema or format, such as a table, a list of records, or a markup or notation, that encodes the visualization information in a machine-readable form.

In one embodiment, a server implements the claimed system as a software application executed by one or more processors on a computing platform that includes a central processing unit, a main memory, a persistent storage device, and a network interface. The server executes an operating system, a runtime environment for a high-level programming language, a relational database management system, and a numerical computation framework. The server is connected, via a communication network, to a data storage device that stores structured data and to one or more terminals operated by users.

The server maintains, in the data storage device, an information structure that defines tables, attributes, keys, and relationships among data entities. The data storage device stores, for example, a sales table, a product table, and a region table, each table including multiple attributes such as identifiers, timestamps, categories, and numerical values. The server acquires and updates metadata describing this information structure, including attribute sets and relation sets, and stores the metadata in a schema repository in the persistent storage. The server uses this metadata as an explicit data structure, such as a graph of nodes and edges representing tables and relationships, to support subsequent processing.

The terminal operates as a user information processing apparatus that presents a graphical user interface, receives a prompt sentence from a user, and displays visualization information. The terminal executes an application or a browser that communicates with the server through a network protocol. The user inputs an information request as a natural-language prompt sentence, such as “Show me last month's sales for the electronics category by region” or “Display the monthly sales trend for all categories over the past year.” The terminal transmits the prompt sentence along with identification information, such as a user identifier or a session token, and environment information, such as a locale and a time zone, to the server.

The server receives the prompt sentence and associated information through the network interface and stores the received data in a request buffer in the main memory. The server normalizes the character encoding of the prompt sentence to a standard encoding and applies a text preprocessing pipeline. The server performs character string normalization to remove control characters and standardize punctuation. The server performs phrase segmentation and tokenization using a vocabulary and tokenizer that were generated during training of the generative AI model. The server converts the tokens into indices referencing an embedding matrix and forms an input data sequence consisting of integer token identifiers and associated position identifiers. The server constructs masks indicating valid token positions and padding positions.

The server loads a generative AI model into the main memory. In one embodiment, the generative AI model is a transformer-based encoder-decoder neural network implemented as a sequence of layers in a numerical computation framework. The encoder includes multiple self-attention layers, each layer computing attention scores between all token positions of the input data sequence using learned weight matrices. The decoder includes self-attention layers and cross-attention layers that attend to encoder outputs. Each layer includes feedforward sublayers with non-linear activation functions and layer normalization. The model parameters, including weight matrices, bias vectors, and normalization parameters, are stored as numerical tensors in the main memory.

The server configures the generative AI model with a specific vocabulary size, number of layers, number of attention heads, and hidden dimensions. During training, the server uses a corpus of training pairs, each pair consisting of a prompt sentence and a corresponding structured representation of a query specification. The server defines a loss function, such as cross-entropy loss between predicted tokens and target tokens, and updates model parameters using a gradient-based optimization algorithm. The server may employ learning rate schedules, regularization techniques, and data augmentation methods such as synonym replacement or paraphrasing to improve generalization. The server stores the trained model parameters in the persistent storage and loads them at runtime for inference.

During inference, the server supplies the input data sequence and masks to the encoder of the generative AI model. The encoder computes, for each token position, context-aware hidden state vectors by applying multi-head self-attention and feedforward operations. The decoder generates an output sequence that represents an intermediate representation of the information request. The intermediate representation is serialized as tokens that correspond to elements such as table identifiers, attribute identifiers, condition operators, literal values, aggregation functions, join specifications, and classification keys. The server decodes the output tokens into a structured intermediate representation, for example a hierarchical structure including a target data set, a condition set, a join set, an aggregation set, and a classification set.

The server validates the intermediate representation by checking consistency with the information structure of the data storage device. The server traverses the schema graph to verify that referenced tables and attributes exist and that join paths are valid. When the intermediate representation includes an ambiguous or incomplete reference, the server applies rule-based disambiguation that uses the relation set and historical usage statistics stored in the schema repository. For example, the server may map the term “electronics category” to an internal category code based on a category mapping table and the attribute definitions. This combination of model-generated structure and explicit schema-based rules enables the server to correct certain errors without human intervention, thereby improving the robustness and accuracy of the overall system.

The server transforms the validated intermediate representation into a query command set in a query language. The server uses a query-building component that maps elements of the intermediate representation to clauses of a query. The server maps each table identifier in the target data set to a table reference in the query language, each attribute identifier to a column reference, each condition to a where-clause predicate, each join specification to a join clause, and each aggregation function to a select expression with grouping. The server constructs an abstract query tree and then serializes the query tree into a textual query command set. The server may apply optimization rules, such as eliminating redundant joins, pushing filter conditions closer to base tables, and selecting appropriate indexes based on the information structure. These optimization rules improve computational efficiency in the data storage device.

The server sends the query command set to the data storage device through a database driver that executes on the server. The data storage device executes the query using its query processor and storage engine, accesses physical storage media, and returns result sets to the server through the database driver. The server receives the result sets as structured data in the main memory and converts the data into an internal tabular format suitable for aggregation processing and formatting processing.

The server performs aggregation processing on the acquired data based on the aggregation set and classification set of the intermediate representation. The server groups records according to classification keys and applies aggregation functions such as sum, count, average, or maximum to numerical attributes. The server uses numerical computation libraries to implement these aggregation operations efficiently on arrays or matrices of values. The server then performs formatting processing, which includes sorting groups according to specified criteria, converting raw values into user-readable units, attaching labels derived from attribute metadata, and organizing the data into a display data set. The display data set contains explicit axis values, series identifiers, and numerical values that correspond to visual elements.

The server generates visualization information from the display data set. The server selects a visualization type based on the structure of the display data set and possibly on patterns inferred from the intermediate representation, such as bar charts for category-based comparisons, line charts for time-series trends, or pie charts for proportion-based displays. The server computes coordinates and visual properties for graphical elements, such as positions and heights of bars, positions of line points, colors assigned to series, and text labels. The server uses a rendering component to transform these graphical elements into image data or into structured data that encodes drawing instructions. For image data, the server renders the visualization into a raster image format in an off-screen buffer in main memory. For structured data, the server outputs a schema of graphical elements that can be rendered by the terminal.

The server transmits the visualization information to the terminal via the network interface. The terminal receives the visualization information and instructs its display hardware to render the visualization. The user views the visualization and may issue additional prompt sentences to refine the analysis, such as “Compare last month's electronics sales by region to the previous month” or “Break down Tokyo's electronics sales by product type.”

The described architecture improves computer technology in several concrete ways. The server reduces the need for hard-coded query templates by using a generative AI model to produce intermediate representations that are aligned with a learned information structure. Because the server explicitly represents schema information in a machine-readable graph and uses that graph both during model training and during runtime validation, the server can adapt to schema changes without rewriting application logic. This reduces maintenance overhead and decreases the likelihood of inconsistent query behavior across different parts of the system.

The server improves processing speed and reduces computational load by transforming the prompt sentence directly into an optimized query command set, rather than performing multiple intermediate translations through manually crafted rule sets. The combination of neural generative modeling for semantic interpretation and rule-based schema validation leads to fewer invalid queries and fewer retries, reducing round-trip times between the server and the data storage device. The aggregation processing and formatting processing are implemented using vectorized numerical operations, which reduce the number of per-record computations and improve throughput.

The server improves accuracy by learning from historical examples of prompt sentences and corresponding query specifications. During training, the server computes gradients of a loss function that penalizes incorrect structure in the intermediate representation, such as missing joins or incorrect aggregation functions. By updating model parameters to minimize this loss, the server learns patterns that are difficult for rule-based systems to capture, such as implicit temporal ranges indicated by phrases like “last month” in different locales. The server further refines predictions using schema-aware post-processing, thereby reducing semantic errors in query generation.

The server reduces communication load by generating visualization information that is tailored to the display data set, rather than transmitting raw, high-volume tabular data to the terminal. For example, when the user requests “Show me last month's sales for the electronics category by region,” the server aggregates the data and transmits only the aggregated results and the visualization information, instead of transmitting all underlying transaction records. This reduction in transmitted data size leads to lower network bandwidth usage and faster response times.

The server processes information in a manner that is not a mere automation of human thought processes. A human analyst typically constructs queries manually by reasoning about tables and relationships and then uses separate tools for visualization. In contrast, the server constructs an internal intermediate representation using a high-dimensional vector space in which token embeddings and attention weights capture complex dependencies that are not explicitly accessible to a human. The server applies multi-head attention and non-linear transformations across entire sequences, using learned weight matrices and optimization-derived parameters, to derive a structured query specification. This processing is inherently machine-centric and relies on large-scale numerical optimization that cannot be practically reproduced by manual human reasoning.

In alternative embodiments, the generative AI model may comprise a recurrent neural network, a convolutional neural network, or a hybrid architecture that combines recurrent and attention mechanisms. The server may employ different loss functions, such as sequence-level reinforcement objectives or auxiliary losses for schema prediction, to further improve intermediate representation quality. The server may also deploy multiple models specialized for different domains or data storage devices and select a model based on the identification information or environment information.

In another embodiment, the server stores the information structure of multiple data storage devices and decides, based on the prompt sentence and the environment information, which data storage device to query. The server may partition the information structure into modular segments and dynamically combine segments at runtime to support scalable multi-tenant architectures. In a further embodiment, the server allows the terminal to request structured visualization information so that the terminal can render interactive graphics locally, while still benefiting from server-side aggregation and optimization.

By implementing the above configurations, the server, the terminal, and the data storage device cooperate to realize a technical system in which the generative AI model, the learned information structure, and the automatic query and visualization generation pipelines provide improved computational efficiency, accuracy, and adaptability in handling natural-language information requests.

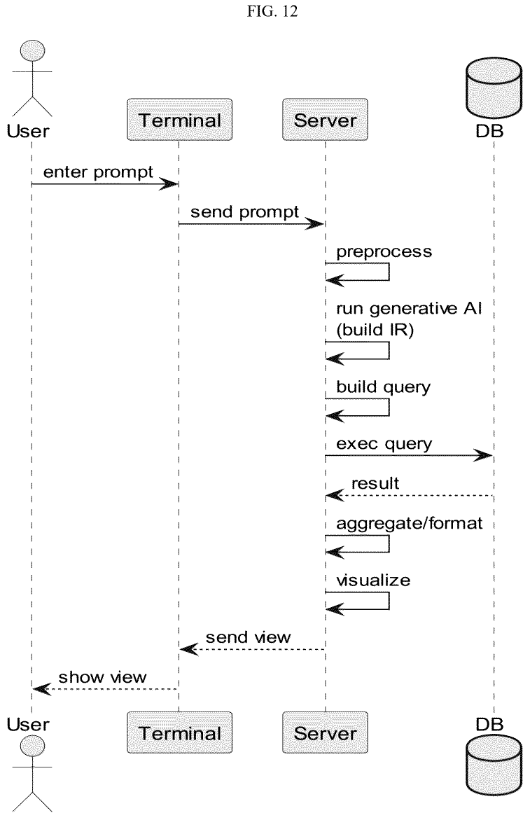

The following describes the processing flow using FIG. 12.

### Step 1

The user operates the terminal to open an application screen that allows input of an information request. The user inputs a prompt sentence in natural language, such as “Show me last month's sales for the electronics category by region,” into a text input field and triggers submission. The input of this step is the user's natural-language prompt sentence as plain text, and the output of this step is the same prompt sentence stored in the terminal's local memory and prepared for transmission.

### Step 2

The terminal collects the prompt sentence together with identification information (for example, a user ID or session token) and environment information (for example, locale and time zone) and constructs a request message. The terminal formats these values into a structured message and sends the message to the server via a communication network. The input of this step is the locally stored prompt sentence and associated metadata on the terminal, and the output of this step is a network request packet containing the prompt sentence and metadata transmitted to the server.

### Step 3

The server receives the network request and extracts the prompt sentence, identification information, and environment information from the request payload. The server validates the request by checking authentication and message size, and stores the extracted data in main memory for further processing. The input of this step is the network request packet arriving at the server's network interface, and the output of this step is an internal representation of the prompt sentence and associated metadata in the server's working memory.

### Step 4

The server preprocesses the prompt sentence to create an input data sequence suitable for the generative AI model. The server performs character string normalization (for example, converting to a unified character set, removing unsupported symbols), applies phrase segmentation and tokenization, and maps each token to a numerical identifier using a predefined vocabulary. The server also adds position identifiers and creates attention masks indicating valid token positions. The input of this step is the raw prompt sentence text, and the output of this step is a tokenized sequence of numerical identifiers with corresponding masks and positional information.

### Step 5

The server supplies the tokenized input data sequence to the generative AI model and executes inference. The server uses a transformer-based encoder-decoder network, where the encoder computes context-aware embeddings for each input token using multi-head self-attention and feedforward layers, and the decoder generates an output token sequence that encodes elements of an intermediate representation. The server runs matrix multiplications, attention weight calculations, and non-linear activations on the token vectors. The input of this step is the tokenized input sequence and masks, and the output of this step is an output token sequence representing a structured intermediate representation of the information request.

### Step 6

The server decodes the output token sequence from the generative AI model into a machine-readable intermediate representation. The server maps output tokens to semantic elements such as table identifiers, attribute identifiers, filter conditions, join specifications, aggregation functions, and classification keys, and organizes these elements into a hierarchical data structure. The input of this step is the model-generated output token sequence, and the output of this step is a structured intermediate representation that includes a target data set, a condition set, a join set, an aggregation set, and a classification set.

### Step 7

The server validates and refines the intermediate representation using the information structure of the data storage device. The server looks up tables and attributes in a schema repository, verifies that referenced elements exist, and checks that join paths are consistent with defined relations. When ambiguous or incomplete references occur, the server applies rule-based corrections using relation definitions and mapping tables. The input of this step is the raw intermediate representation from the generative AI model and the stored schema metadata, and the output of this step is a validated and possibly corrected intermediate representation that is consistent with the actual data storage schema.

### Step 8

The server converts the validated intermediate representation into a query command set in a query language. The server constructs an abstract query tree by mapping target tables to from-clauses, conditions to where-clauses, join specifications to join-clauses, and aggregation and classification information to select and group-by clauses. The server then serializes this abstract query tree into one or more textual query commands optimized for the underlying data storage device. The input of this step is the validated intermediate representation, and the output of this step is a query command set expressed in a query language.

### Step 9

The server sends the query command set to the data storage device through a database driver and waits for execution results. The data storage device executes the query commands, accesses physical storage, and returns result records. The server receives the result records via the database driver and loads them into an internal tabular data structure in main memory. The input of this step is the textual query command set, and the output of this step is a structured result set containing rows and columns of acquired data.

### Step 10

The server performs aggregation processing on the result set according to the aggregation set and classification set in the intermediate representation. The server groups rows based on classification keys (for example, region or time period) and applies aggregation functions (for example, sum, count, or average) to numerical columns using vectorized arithmetic operations. The server then performs formatting processing, including sorting groups, converting units, rounding values, and attaching labels, to construct a display data set tailored for visualization. The input of this step is the raw result set from the data storage device and the aggregation and classification instructions, and the output of this step is a display data set that organizes values and labels for presentation.

### Step 11

The server generates visualization information from the display data set. The server selects a chart type based on the data structure (for example, bar chart for “sales by region” or line chart for “sales over time”), computes coordinates for graphical elements (for example, x-axis positions for categories and y-axis heights for aggregated values), assigns colors and legends, and generates axis labels and titles. The server then renders these graphical elements into image data in an off-screen buffer or encodes them as structured data describing shapes and attributes. The input of this step is the display data set, and the output of this step is visualization information represented as image data or structured visualization instructions.

### Step 12

The server transmits the visualization information to the terminal over the communication network. The terminal receives the visualization information, decodes any encoded image or structured data, and renders the visualization on its display device using its graphics subsystem. The user views the visualization, interprets the results, and may input a new prompt sentence to refine or extend the analysis, such as “Compare last month's electronics sales by region to the previous month” or “Break down Tokyo's electronics sales by product type.” The input of this step on the server side is the visualization information in internal memory, and the output of this step is the visualization displayed on the terminal and observable by the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional data retrieval systems generally require a user to manually formulate a query in a structured query language according to a predetermined schema of a data storage apparatus. In such systems, a processing device typically receives a natural-language request merely as free text and does not reliably transform the request into an executable query while taking into account table structures, column attributes, and safety constraints. As a result, the systems either depend on static rule-based mapping from natural language to query language, which is brittle and hard to maintain, or they rely on generic language models without integrating schema-specific learning or robust validation mechanisms. This leads to inaccurate queries, unexpected failures at execution time, and additional latency due to repeated trial-and-error interactions between the user and the system.

Moreover, in many existing approaches, a generative AI model is invoked in an ad hoc manner, without an explicit prompt design that systematically incorporates attribute information of the tabular structure and extracted elements of the user's request. When the generative AI model is not guided by a schema-aware prompt sentence, the model may generate a query that references non-existent fields, uses an inappropriate aggregation type, or omits constraints that are implicit in the user's intent. This degrades the technical performance of the overall computing system, increases compute consumption on both the model side and the database side, and reduces throughput and reliability of query processing.

Further, conventional systems typically do not perform structured safety checks on an AI-generated query before sending it to the data storage apparatus. Without explicit verification against allowed expressions and reference constraints, the system may generate queries that are syntactically valid but semantically unsafe or out of policy, forcing system designers to impose coarse-grained restrictions (for example, blocking entire classes of queries) that lower system flexibility and throughput. Additionally, many systems return raw query results directly to the client application, requiring client-side logic to interpret database outputs and construct user-readable responses, which increases client complexity and can cause inconsistent behavior among different client implementations.

Therefore, there is a need for a technical mechanism in which a processor learns attribute information from a tabular structure of a data storage apparatus, constructs a schema-aware prompt sentence that instructs a generative AI model in a controlled way, validates a generated query language against predefined safety constraints, and transforms database execution results into an internal data structure from which a natural-language response sentence is generated on the server side. Such a mechanism should improve the correctness, safety, and efficiency of query generation and execution, thereby improving the functioning of the computer system itself, including its resource utilization, latency characteristics, and robustness of data retrieval operations.

The specific processing by the specific processing unit 290 of the data processing device 12 in Example 2 is realized by the following means.

The present invention provides a server comprising a processor configured to analyze a tabular structure of a data storage apparatus so as to acquire attribute information regarding the tabular structure and to learn the tabular structure based on the attribute information; to receive, from a terminal operated by an information requester, an information request expressed in a natural language or in a predetermined format, and to construct a prompt sentence based on content of the information request and the attribute information so as to instruct a generative information processing model to generate a query language; to input the prompt sentence to the generative information processing model, to obtain, from the generative information processing model, the query language as an output, to perform a safety check on the query language based on allowed expressions and constraints on referenced objects, and to transmit the query language to the data storage apparatus for execution so as to obtain numerical information or item information as an execution result; and to convert the obtained numerical information or item information into an internal data structure, to generate a natural-language response sentence based on the internal data structure, and to transmit the response sentence to the terminal for display. This enables the server to integrate schema-aware prompt generation, controlled use of a generative AI model, structured validation of the generated query language, and server-side natural-language response generation, thereby improving the technical performance of the overall computer system in terms of accuracy, safety, and efficiency of data retrieval processing.

The term “processor” refers to a hardware or virtual computation unit, such as a central processing unit or a processing core in an information processing apparatus, that executes instructions to perform analysis, generation, validation, and communication operations described in this specification.

The term “system” refers to an arrangement including at least one processor, at least one data storage apparatus, and at least one terminal, which cooperate via one or more communication paths to perform the processes described in this specification.

The term “data storage apparatus” refers to any hardware or software-based storage system that holds structured data, such as a database system, a data warehouse system, or a similar data management system.

The term “tabular structure” refers to a logical organization of data in the data storage apparatus in the form of one or more tables, each table including rows and columns representing records and fields, respectively.

The term “attribute information” refers to information describing properties of the tabular structure, including at least table names, column names, data types, relationships between tables, and permissible values or constraints associated with the columns.

The term “learn the tabular structure” refers to a process in which the processor acquires and stores attribute information of the tabular structure and prepares internal representations or models that allow subsequent mapping from natural-language elements to corresponding tables, columns, and constraints.

The term “terminal” refers to an information processing device operated by a user, such as a client apparatus, computing device, or user interface device, that transmits information requests to the system and receives response information from the system.

The term “information requester” refers to a human user or an automated agent that operates the terminal to submit an information request to the system.

The term “information request” refers to a request specifying desired information or data retrieval conditions, expressed in a natural language or in a predetermined structured format, and transmitted from the terminal to the system.

The term “natural language” refers to a human language expression that is not constrained to a programming language or strict query language syntax and that can be freely written or spoken by the information requester.

The term “predetermined format” refers to a structured representation format other than a natural language, such as a parameterized template, form-based representation, or machine-readable data structure, which is predefined for expressing an information request.

The term “prompt sentence” refers to a text sequence or textual data structure that is constructed by the processor and provided as input to a generative information processing model in order to instruct the model to perform a specific task, such as generating a query language expression.

The term “generative information processing model” refers to a model based on machine learning or artificial intelligence, such as a generative language model, that receives a prompt sentence and generates an output text, including at least a query language expression, according to learned patterns.

The term “query language” refers to a formal language used to retrieve or manipulate data in the data storage apparatus, such as a structured query language, including any dialect or variant thereof suitable for execution by the data storage apparatus.

The term “safety check” refers to a validation process applied by the processor to a query language expression to confirm that the expression satisfies predefined safety rules, including at least verification of allowed expressions, disallowed operations, and constraints on referenced objects.

The term “allowed expressions” refers to tokens, keywords, operators, and syntactic forms that are permitted to appear in the query language according to system policies or configuration information.

The term “constraints on referenced objects” refers to rules or limitations defining which tables, columns, or other data objects in the data storage apparatus may be referenced, accessed, or manipulated by the generated query language.

The term “execution result” refers to data returned from the data storage apparatus after the apparatus executes a query language expression, including values computed or retrieved in response to the information request.

The term “numerical information” refers to one or more values of numeric data type included in the execution result, such as counts, sums, averages, or other measured or computed quantities.

The term “item information” refers to one or more values of non-numeric data type included in the execution result, such as identifiers, names, categories, time values, or other descriptive data elements.

The term “internal data structure” refers to a representation of the execution result within the system, such as an object or record comprising fields that organize numerical information and item information in a form suitable for further processing, including natural-language generation.

The term “natural-language response sentence” refers to a text expression in a human language generated by the processor based on the internal data structure so as to present the execution result in an understandable form to the information requester.

The term “selectively analyze” refers to a process in which the processor analyzes only part of the tabular structure, such as a subset of tables or columns, based on relevance to an information request or predefined selection criteria.

The term “items related to the information request” refers to elements of the tabular structure, such as particular tables or columns, that are determined by the processor to correspond to entities, attributes, or conditions specified or implied in the information request.

The term “target item” refers to an element of data in the tabular structure, such as a particular column or field, that the information requester is interested in obtaining or aggregating.

The term “target period” refers to a temporal condition derived from the information request, such as a specific date, date range, or time interval, that constrains the data retrieval in the query language.

The term “calculation type” refers to a kind of data processing or aggregation operation derived from the information request, such as summation, averaging, counting, filtering, grouping, or comparison.

The term “embed an extraction result into the prompt sentence” refers to an operation in which the processor incorporates extracted elements, including at least the target item, target period, and calculation type, together with attribute information of the tabular structure, into the text of the prompt sentence so that the generative information processing model is explicitly guided to generate an appropriate query language.

In one embodiment, a server includes a processor, a main memory, a non-transitory storage medium, and a network interface, and is connected via a communication network to at least one terminal and at least one data storage apparatus. The terminal is, for example, a smartphone, a tablet, or a personal computer executing a browser application or a dedicated client application. The data storage apparatus is, for example, a relational database system or a data warehouse system executing on a storage server. The server executes a program stored in the non-transitory storage medium to realize the functions described below.

The server stores, in the non-transitory storage medium, at least a schema-analysis module, a schema-mapping module, a prompt-construction module, a generative AI model interface module, a query-safety module, an execution-control module, a result-structuring module, and a natural-language generation module. The server further stores configuration data including table names, column names, data types, access policies, and safety rules that define allowed expressions and constraints on referenced tables and columns.

The server analyzes a tabular structure of the data storage apparatus by using the schema-analysis module. The server acquires metadata from the data storage apparatus through the network interface by issuing metadata queries in a query language supported by the data storage apparatus. In one example, the data storage apparatus executes a relational database management engine, and the server acquires table definitions, column definitions, indexes, foreign-key relationships, and statistics from catalog tables. The server stores this attribute information in the main memory and in the non-transitory storage medium as a schema representation.

The server learns the tabular structure by constructing internal data structures that map between natural-language-like labels and individual tables and columns. The server employs the schema-mapping module to normalize table and column names, to compute tokenized representations of these names, and to associate each column with semantic tags such as “product identifier,” “date,” or “amount.” The server may compute numerical feature vectors for each column name and table name by applying a word-embedding model or a subword tokenizer, so that semantically similar names are placed near each other in a vector space. The server thereby prepares a data structure in which a natural-language expression contained in an information request can be efficiently matched to a particular table or column.

The server receives an information request from the terminal. The user operates the terminal and inputs an information request expressed in a natural language, such as “I want to know the sales of product A in the first quarter of last year.” The terminal converts the user's input into a text payload and transmits the payload to the server via a network protocol such as HTTPS. The server receives the payload by the network interface, and the processor stores the text of the information request in the main memory. The server may also receive, in association with the information request, user identifiers, locale information, and preference settings.

The server analyzes the information request by using the schema-mapping module and a request-analysis submodule. The server performs tokenization of the request text, applies part-of-speech tagging, and computes an embedding representation of the request by applying a neural network model stored in the non-transitory storage medium. In one embodiment, the server uses an encoder based on a transformer architecture comprising multiple self-attention layers, each layer including query, key, and value projections and a position-wise feed-forward network. The server uses the encoder to produce contextualized embeddings for each token in the information request.

The server matches specific tokens or phrases, such as “product A,” “first quarter of last year,” and “sales,” with the internal schema representation by computing similarity scores between the token embeddings and the column-name embeddings. The server selects a target item (for example, a “sales amount” column), a target period (for example, a date range from a first date to a second date), and a calculation type (for example, summation) based on the similarity scores and heuristic rules. These heuristic rules include, for example, that tokens associated with a numerical measure are likely to map to measure columns, and tokens expressing time ranges are likely to map to date or timestamp columns. By performing this matching, the server extracts structured query parameters from the natural-language information request.

The server constructs a prompt sentence by using the prompt-construction module. The server concatenates a system description, a schema description, and the extracted query parameters into a single textual instruction to a generative AI model. The server may use a prompt sentence such as:

“You are a system that converts user questions into SQL queries for an analytics database.

The main table is ‘sales_data’ with columns: product (STRING), date (DATE, format ‘YYYY-MM-DD’), sales (INTEGER, in yen).

Generate a single SQL query that returns the total sales amount for the requested conditions.

Output only the SQL query, without explanation.

User question: ‘I want to know the sales of product A in the first quarter of last year.’”

The server stores the prompt sentence in the main memory and passes the prompt sentence to the generative AI model interface module.

The server interfaces with a generative AI model by using the generative AI model interface module. In one embodiment, the server communicates with an external generative AI model provided by a model service over a network. In another embodiment, the server executes a generative AI model locally on a dedicated computation device including a graphics processing unit or a tensor processing unit. The generative AI model is, for example, a transformer-based language model that has been trained on large amounts of text data and further fine-tuned on query-generation tasks.

The generative AI model comprises an embedding layer that converts each input token of the prompt sentence into a vector, a stack of multiple transformer layers, and an output layer that maps the final hidden state of each token to a probability distribution over output tokens. Each transformer layer includes a multi-head self-attention mechanism and a position-wise feed-forward network. During inference, the generative AI model receives the prompt sentence and sequentially predicts tokens of an output sequence representing a query language expression. The server sets inference parameters, such as a low temperature and a deterministic decoding method, so that the generative AI model generates stable and reproducible query language expressions. The server obtains the output text of the generative AI model as a candidate query language expression.

The server performs a safety check on the candidate query language expression by using the query-safety module. The server tokenizes the query language expression into keywords, identifiers, and operators, and compares each token against a list of allowed expressions stored in the non-transitory storage medium. The server determines whether the query language expression includes disallowed operations, such as data modification commands or system-control commands. The server further analyzes references to tables and columns and verifies that each referenced object is included in an allowable set predetermined for the user or for the application. If the query language expression fails the safety check, the server may modify the prompt sentence to further constrain the generative AI model, or may generate a fallback query based on a deterministic template. If the query language expression passes the safety check, the server forwards the query language expression to the execution-control module.

The server transmits the verified query language expression to the data storage apparatus and controls execution by using the execution-control module. The server maintains a pool of connections to the data storage apparatus and selects a connection according to load-balancing rules. The server sends the query language expression over the selected connection and waits for execution to complete. The data storage apparatus parses the query, selects an execution plan, performs operations such as table scanning, index lookup, join processing, and aggregation, and returns the execution result to the server. The execution result may include at least numerical information and item information. The server receives the execution result via the network interface and stores it in the main memory.

The server converts the execution result into an internal data structure by using the result-structuring module. The server maps each column of the result set into a field in a structured object, and, if necessary, converts units, rounds numerical values, or groups records according to configuration parameters. The server thereby generates a machine-readable representation suitable for subsequent natural-language generation.

The server generates a natural-language response sentence by using the natural-language generation module. In one embodiment, the server uses a template-based method, in which templates are stored in the non-transitory storage medium and filled with values from the internal data structure. For example, the server may use a template:

“The sales of product {product} in the first quarter of last year were {amount} yen.” and replace the placeholders with concrete values to form a response such as: “The sales of product A in the first quarter of last year were 5,000,000 yen.”

In another embodiment, the server constructs a second prompt sentence that includes the original information request and the internal data structure, and transmits the second prompt sentence to the generative AI model, which returns a natural-language response sentence. The server may use a second prompt sentence such as: “User question: ‘I want to know the sales of product A in the first quarter of last year.’

Database result: total_sales=5000000 (yen).

Generate a concise English sentence that answers the user's question using this value. Output only the sentence.”

The server selects a generation method based on system configuration, user preference, or performance constraints.

The server transmits the natural-language response sentence to the terminal via the network interface. The terminal receives the response and displays the response sentence in a user interface area such as a text panel or a message window. The user reads the natural-language response sentence on the terminal display. Because the server has already combined schema knowledge, AI-based query generation, safety validation, and result explanation, the terminal may remain relatively simple and does not need to implement complex query-generation logic.

This configuration yields technical effects that go beyond mere automation of human mental steps. The server improves the functioning of the computer system by tightly integrating schema-aware analysis, generative AI model guidance via prompt sentences, structured safety validation, and efficient execution control. By learning the tabular structure and embedding schema attributes into prompt sentences, the server reduces the frequency of invalid or semantically incorrect queries produced by the generative AI model. This reduces the number of failed executions at the data storage apparatus, lowers the consumption of computation resources, and decreases network traffic caused by repeated retries.

The server further improves processing speed and latency. Because the server precomputes embeddings of table and column names and uses vector similarity search to match natural-language tokens to database schema elements, the mapping from information request to structured query parameters is executed in sublinear time with respect to the schema size. This is significantly faster than naive exhaustive search or repeated user interaction. The use of deterministic safety checks and constrained decoding reduces the search space of possible query language expressions, thereby decreasing inference time on the generative AI model and reducing computational load on the model hardware.

The server also improves precision and robustness of data retrieval. By extracting explicit target items, target periods, and calculation types and embedding them into the prompt sentence, the server gives the generative AI model clear constraints that align with the actual schema. As a result, the generated query language expression is more likely to match the true intent of the user and to align with the available columns and tables. Error rates due to column-name mismatches, missing filters, or incorrect aggregation are reduced. The uniform preparation of internal data structures and server-side natural-language response generation further ensures that different terminals receive consistent and technically accurate explanations.

The generative AI model in this system does not simply replace human reasoning, but operates under machine-oriented constraints that are specifically designed to exploit the capabilities of the computing platform. For example, the server configures the generative AI model with a low temperature and a beam search or greedy decoding strategy to avoid unnecessary variability, and uses prompt sentences that include explicit schema constraints and examples. These measures cause the generative AI model to behave like a specialized query synthesis engine rather than a general conversational agent, thereby improving computational efficiency and reducing ambiguity.

The server may employ various learning methods to refine model behavior. The server may accumulate pairs of information requests and successfully executed query language expressions, and perform supervised fine-tuning or reinforcement learning on the generative AI model. In supervised fine-tuning, the server uses a loss function such as cross-entropy to minimize the difference between the generated tokens and tokens of ground-truth queries. In reinforcement learning, the server may define a reward based on successful execution and correctness of results, and adjust model weights through gradient-based optimization. The server thereby adapts the generative AI model to the specific schema and usage patterns of the data storage apparatus, which further improves performance and reduces error rates.

The system can be realized in multiple variations. In one variation, the server uses an external model service for the generative AI model and focuses on prompt construction, safety validation, and execution control. In another variation, the server runs a dedicated generative AI model locally and may modify internal layers or attention patterns to directly incorporate schema embeddings as additional input. In yet another variation, the server combines multiple generative AI models or rule-based modules and selects an appropriate module based on the complexity of the information request.

The described embodiments focus on computer-internal technical processing such as representation of schema information in vector spaces, transformer-based encoding of information requests, algorithmic construction of prompt sentences, and formal safety analysis of generated query language expressions. The server thereby improves resource utilization, processing speed, and reliability of the computer system, and these improvements are realized through specific data structures, algorithms, and model configurations rather than through a mere change of business rules or manual workflows.

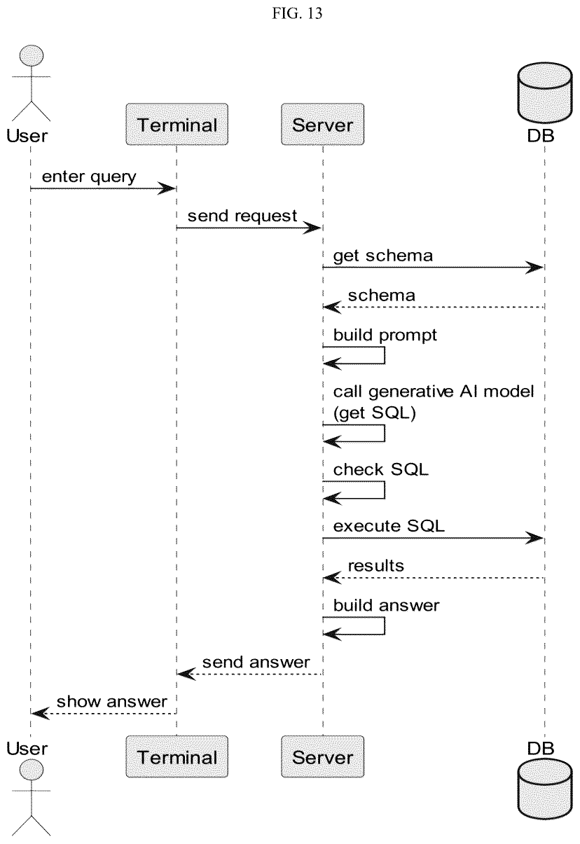

The following describes the processing flow using FIG. 13.

### Step 1

User operates the terminal and inputs an information request.

User views an input field on the terminal screen and types a natural-language request such as “I want to know the sales of product A in the first quarter of last year.”

The input of this step is the user's keystrokes or touch events on the terminal.

The terminal converts these events into a text string and forms a request object that includes at least the text of the information request and user identification data.

The output of this step is a structured request payload containing the information request text and metadata, held in the terminal's memory.

### Step 2

Terminal sends the information request payload to the server.

Terminal establishes a network connection to the server using a communication protocol such as HTTPS and serializes the request payload into a transport format.

The input of this step is the structured request payload generated in Step 1.

The terminal performs data processing that includes encoding the text into a character set, adding headers such as authentication tokens, and encapsulating the payload into a network message.

The output of this step is a transmitted network message that reaches the server and contains the information request text and associated metadata.

### Step 3

Server receives and validates the information request.

Server accepts the network message via a network interface and parses headers and body to reconstruct the request payload.

The input of this step is the network message sent from the terminal.

The server performs data processing that includes syntax checking of the payload format, verification of user authentication information, and confirmation that the information request text is present and within an allowable length.

The output of this step is a validated information request object stored in the server's main memory, including the request text, user identity, and context parameters.

### Step 4

Server acquires or updates schema attribute information from the data storage apparatus.

Server connects to the data storage apparatus and executes metadata queries to obtain table names, column names, data types, and relationships.

The input of this step is a schema-fetch trigger derived from configuration settings or from a cache-miss condition, and a connection handle to the data storage apparatus.

The server performs data processing that includes parsing the metadata response, extracting table and column descriptions, and constructing an internal schema representation such as a list of tables and columns with associated attributes.

The output of this step is updated attribute information and a tabular-structure representation stored in the server's memory for later use in mapping and prompt construction.

### Step 5

Server computes embeddings and semantic tags for schema elements.

Server applies a tokenizer and an embedding function to each table name and column name, and then assigns semantic tags such as “measure,” “dimension,” “time,” or “identifier.”

The input of this step is the attribute information and tabular-structure representation produced in Step 4.

The server performs data processing that includes converting names into token sequences, mapping tokens into numerical vectors by an embedding model, and clustering or classifying vectors to derive semantic tags.

The output of this step is an enriched schema map that associates each schema element with an embedding vector and semantic tags, stored in server memory for fast lookup.

### Step 6

Server analyzes the natural-language information request and extracts structured query parameters.

Server tokenizes the information request text and encodes it with a neural-network encoder to obtain contextual embeddings for each token and for the whole sentence.

The input of this step is the validated information request object from Step 3 and the enriched schema map from Step 5.

The server performs data processing that includes computing similarity scores between token embeddings from the request and embedding vectors of schema elements, and applying selection rules based on those scores and semantic tags.

The server derives a target item (for example, a sales amount column), a target period (for example, a specific date range), and a calculation type (for example, sum, average, or count). The output of this step is a structured parameter set that expresses the information request in terms of schema elements and operations, stored as a data structure in server memory.

### Step 7

Server constructs a schema-aware prompt sentence for the generative AI model.

Server combines a system instruction, a description of the relevant tables and columns, and the structured query parameters into a single textual prompt.

The input of this step is the structured parameter set from Step 6 and the schema map from Step 5.

The server performs data processing that includes selecting the main table name, listing relevant column names with their roles, converting the target period into explicit date boundaries, and formatting these elements into coherent natural-language instructions.

The server may generate a prompt sentence such as:

“You are a system that converts user questions into SQL queries for an analytics database.

The main table is ‘sales_data’ with columns: product (STRING), date (DATE, format ‘YYYY-MM-DD’), sales (INTEGER, in yen).

Generate a single SQL query that returns the total sales amount for the requested conditions.

Output only the SQL query, without explanation.

User question: ‘I want to know the sales of product A in the first quarter of last year.’”

The output of this step is a prompt sentence string ready to be consumed by the generative AI model, held in the server's memory.

### Step 8

Server sends the prompt sentence to the generative AI model and obtains a candidate query language expression.

Server passes the prompt sentence to a generative AI model interface, which communicates with a transformer-based language model.

The input of this step is the prompt sentence generated in Step 7.

The server performs data processing that includes encoding the prompt into tokens, forwarding those tokens to the generative AI model, and receiving a sequence of output tokens produced by the model.

The generative AI model processes the prompt using internal attention mechanisms and autoregressive decoding to form a query language expression such as a structured query.

The output of this step is a candidate query language string, such as a structured query language statement, reconstructed from the generated token sequence and stored in server memory.

### Step 9

Server performs a safety check and normalization on the generated query language.

Server inspects the candidate query language to ensure that it conforms to policy and references only permitted schema elements.

The input of this step is the candidate query language string from Step 8 and a safety-rule set stored in the server's storage.

The server performs data processing that includes tokenizing the query string, comparing tokens against allowed keyword lists, rejecting disallowed statements, and checking each table and column reference against the schema map and access constraints.

The server may also normalize formatting by removing extraneous characters, redundant whitespace, or non-executable wrapper text.

The output of this step is a verified and normalized query language expression ready for execution, or an indication that the candidate query is unsafe, in which case an error structure or alternative query plan is generated.

### Step 10

Server sends the verified query language expression to the data storage apparatus and obtains an execution result.

Server uses an execution-control module to select a database connection and to transmit the verified query to the data storage apparatus.

The input of this step is the verified query language expression from Step 9 and a connection object to the data storage apparatus.

The server performs data processing that includes formatting the query into the native protocol of the data storage apparatus, issuing the query, and then receiving rows of result data.

The data storage apparatus executes physical operations such as scanning, joining, filtering, and aggregating, and sends the resulting data back to the server.

The output of this step is a raw execution result set, which may include numerical values and item fields, stored temporarily in server memory.

### Step 11

Server converts the execution result set into an internal data structure.

Server parses the result set and maps columns and rows into a structured representation, such as an object with named fields corresponding to the target item and associated attributes.

The input of this step is the raw execution result set from Step 10 and the structured parameter set from Step 6.

The server performs data processing that includes reading each row of the result, extracting the relevant numeric measure (for example, total sales) and related descriptors (for example, product identifier and date range), and applying unit conversion or rounding rules as needed.

The output of this step is a normalized internal data structure that encapsulates the essential result information in a machine-usable format, stored in server memory.

### Step 12

Server generates a natural-language response sentence from the internal data structure.

Server uses a natural-language generation module, which may be template-based or powered by a generative AI model, to convert the internal data structure into a user-readable sentence.

The input of this step is the internal data structure produced in Step 11 and, optionally, template definitions or a secondary prompt pattern.

The server performs data processing that includes selecting a language pattern, inserting numeric values and item names into placeholder positions, or constructing a second prompt sentence that describes the original question and the computed result.

For example, the server may create a sentence: “The sales of product A in the first quarter of last year were 5,000,000 yen.”

The output of this step is a natural-language response string ready to be sent to the terminal.

### Step 13

Server sends the natural-language response to the terminal.

Server encapsulates the response sentence and, optionally, additional details such as the generated query language and raw numeric values into a response message.

The input of this step is the natural-language response string from Step 12 and any supplementary data to be returned.

The server performs data processing that includes serializing the response into a transfer format, attaching appropriate headers, and transmitting the response over the network interface to the terminal.

The output of this step is a network message containing the response, delivered to the terminal.

### Step 14

Terminal receives and displays the natural-language response to the user.

Terminal parses the response message, extracts the response sentence and any accompanying data, and updates its user interface.

The input of this step is the network message transmitted from the server in Step 13.

The terminal performs data processing that includes deserializing the message, rendering the response text in a display area, and optionally presenting additional details in secondary views such as expandable panels.

The output of this step is a visual presentation of the response sentence on the terminal's screen, allowing the user to understand the result that was computed and retrieved by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional data access systems require a human developer or a technically skilled user to manually design and maintain query logic that is tightly coupled to a particular database schema and a particular query language. When a user issues an information request in natural language, the system typically performs only shallow keyword search or relies on a fixed set of pre-defined queries. As a result, the system cannot flexibly translate diverse natural-language requests into accurate query language expressions over complex, evolving data structures. Moreover, existing natural-language-to-query systems that attempt to use machine learning or rule-based techniques are generally schema-agnostic or rely on static schema mappings prepared in advance. When the underlying data structure changes, such as when new tables or attributes are added, those systems must be manually reconfigured or retrained. This leads to high maintenance costs, brittle behavior, and a lack of scalability in dynamic enterprise environments. In addition, conventional systems handle each user request uniformly, without taking into account a real-time emotional state of the user. The same query translation and execution path is used regardless of whether the user is confused, frustrated, or merely exploring data. Consequently, the system cannot dynamically adjust query scope, priority, or level of detail based on user emotion, and thus cannot optimize computational resource allocation or response content in a way that improves user experience and overall system efficiency.

Furthermore, even when a generative AI model is used to assist in query generation, existing approaches often send only a raw natural-language question to the model. Without explicit, structured schema information embedded into a prompt sentence, the generative AI model may produce syntactically valid but semantically incorrect query language that references non-existent tables or attributes, or that uses sub-optimal filters or joins. This leads to increased failure rates, unnecessary retries, wasted compute cycles, and unstable performance.

Accordingly, there is a need for a computer-implemented system that improves the core data access pipeline itself: a system that (i) programmatically analyzes and learns the data structure of a storage device, (ii) constructs schema-aware prompt sentences for a generative AI model, (iii) automatically generates and validates query language based on both the learned schema and the user's information request, and (iv) dynamically adjusts query content and processing priority using an estimated emotional state of the user. Such a system would constitute an improvement in computer technology by enabling more accurate, adaptive, and resource-efficient query generation and execution in response to natural-language requests.

The specific processing by the specific processing unit 290 of the data processing device 12 in Application Example 2 is realized by the following means.

The present invention provides a server comprising a processor configured to analyze a data structure stored in a storage device and to learn the data structure, to receive from a user an information request expressed in natural language via an input terminal, to generate a schema-aware prompt sentence that instructs a generative AI model to generate a query language based on a content of the information request and the learned data structure, to estimate an emotional state of the user based on at least one of voice information, image information, and text information associated with the user, to adjust at least one of a content of the prompt sentence, a content of the query language, and a processing priority of the information request in accordance with the emotional state, to input the prompt sentence to the generative AI model so as to automatically generate the query language, to validate the generated query language against the learned data structure, to acquire desired information from the storage device based on the validated query language, and to cause the acquired information to be presented to the user via a visual display device or an audio output device. This enables the computer system itself to more accurately and efficiently translate natural-language information requests into executable query language that is consistent with the current data structure, to dynamically tailor query scope and scheduling based on user emotion, and thereby to improve overall computational performance, robustness, and responsiveness of data retrieval operations in comparison with conventional systems that lack schema-aware prompt construction and emotion-adaptive query control.

The term “system” refers to an arrangement of one or more computing devices, including at least one processor and one or more storage devices and input/output devices, that cooperate to perform the functions recited in the claims.

The term “processor” refers to a hardware processing unit, such as a central processing unit, a microprocessor, a microcontroller, a graphics processing unit, or a combination thereof, that executes machine-readable instructions to implement the claimed operations.

The term “storage device” refers to any non-transitory computer-readable medium, such as a magnetic storage medium, an optical storage medium, a semiconductor memory, or a combination thereof, that stores data and/or instructions used by the processor.

The term “data structure” refers to an organized representation of data stored in the storage device, including but not limited to tables, fields, records, relationships, schemas, and metadata that define how the data is logically arranged.

The term “table” refers to a logical construct within the data structure that organizes data into rows and columns, where each column corresponds to an attribute and each row corresponds to a record.

The term “table name” refers to an identifier used to designate a specific table within the data structure.

The term “item name” refers to an identifier used to designate a specific attribute, field, or column within a table of the data structure.

The term “data type” refers to a classification of data values stored in a field or column, such as numeric, textual, date/time, or boolean, that constrains how the values are stored and processed.

The term “learn the data structure” refers to causing the processor to analyze and obtain information about the organization of the data within the storage device, including table names, item names, data types, and relationships, and to store such information in a form usable for subsequent processing.

The term “user” refers to any human operator or external entity that issues an information request to the system through an input device or communication interface.

The term “input terminal” refers to any device or interface that allows the user to input information to the system, including but not limited to a keyboard, a pointing device, a touch panel, a microphone, a camera, or a combination thereof.

The term “information request” refers to a request, expressed by the user, for retrieval or presentation of data stored in the storage device, the request being described in natural language or in a specified format.

The term “natural language” refers to a human language, such as a spoken or written language used in everyday communication, that is not restricted to a predefined formal query syntax.

The term “generative artificial intelligence model” refers to a machine-learned model that, in response to input text or other data, generates output text or other data, and that is capable of generating a query language expression when provided with an appropriate prompt sentence.

The term “prompt sentence” refers to a text sequence or message provided as input to the generative artificial intelligence model, the text sequence including instructions, context, and/or schema information that guide the model to generate a desired query language expression.

The term “query language” refers to a formal language used to specify operations for retrieving, filtering, or aggregating data stored in the storage device, and includes, for example, a structured query language.

The term “schema information” refers to information that describes the structure of the data stored in the storage device, including at least one of table names, item names, data types, and relationships between tables.

The term “visual display device” refers to any device that outputs visual information to the user, such as a monitor, a handheld display, a head-mounted display, smart glasses, or a projection device.

The term “audio output device” refers to any device that outputs audio information to the user, such as a speaker, an earphone, or a headset.

The term “voice information” refers to data representing spoken utterances of the user, including raw audio signals and features extracted from the audio signals.

The term “image information” refers to data representing visual characteristics of the user or an environment, including still images, video frames, and features extracted from such images.

The term “text information” refers to character-based data corresponding to user input or system-generated content, including transcriptions of spoken utterances and text entered via a keyboard or other input means.

The term “emotional state” refers to a psychological state of the user, such as joy, anger, frustration, interest, or neutrality, inferred from one or more of voice information, image information, and text information.

The term “processing priority” refers to a level or order of precedence assigned to processing of an information request, which influences scheduling, resource allocation, or responsiveness of the system.

The term “retrieval items” refers to specific attributes, fields, or data elements that are selected or requested to be returned by the query language expression.

The term “aggregation conditions” refers to rules or parameters in the query language that specify how data is combined or summarized, including grouping keys, aggregate functions, and aggregation scopes.

The term “sorting conditions” refers to rules or parameters in the query language that specify an order in which query results are arranged, including one or more sort keys and sort directions.

The term “degree of interest or dissatisfaction” refers to a quantified or categorized representation of how strongly the user appears to be interested in or dissatisfied with the requested information, derived from the estimated emotional state.

In one embodiment, a server cooperates with one or more terminals operated by a user to implement a system that translates natural-language information requests into query language statements using a generative AI model, while taking into account an estimated emotional state of the user. The server comprises at least one processor, a main memory, a non-transitory storage device, a network interface, and a display or audio output interface. The terminal comprises an input unit such as a keyboard, a pointing device, a touch-sensitive panel, a microphone, and a camera, and an output unit such as a display or a speaker. The server and the terminal are connected via a wired or wireless communication network.

The server executes an operating system, such as a general-purpose server operating system running on a processor architecture such as an x86 processor or an ARM-based processor. The server executes application software implemented, for example, in a high-level programming language. The server stores a database management system, such as a relational database engine, in the storage device. The server further stores a trained generative AI model and one or more machine-learned emotion estimation models in the storage device.

The server analyzes a data structure of a database stored in the storage device. The server uses a database access library to issue metadata queries to the database engine. The server obtains table definitions, column names, data types, primary keys, foreign keys, and other schema information. The server converts the returned metadata into an internal representation, such as a relational schema graph stored in memory. The server maintains this schema graph with adjacency lists or matrices that represent relationships between tables and fields. By doing so, the server learns the data structure and associates attribute semantics (such as typical value ranges or domain categories) with fields by scanning sample data and computing descriptive statistics. The server constructs a schema index that maps natural-language expressions to possible fields and tables. The server computes this mapping by processing column names, column comments, and sample values through a tokenization procedure and by generating distributional word embeddings, for example using a pre-trained word embedding model. The server thus associates each column with one or more embedding vectors and stores these vectors in a vector index. This index allows the server to compute similarity between user terms and schema elements efficiently. This internal data processing is not performed step-by-step by a human operator, but is performed automatically and incrementally by the server, and enables the server to adapt to schema changes without manual reprogramming.

The terminal captures a natural-language information request from the user. The user may enter text using the keyboard or touch panel of a smartphone, or speak into a microphone of a headset or a smart glasses device. The terminal executes a speech recognition client that transmits an audio stream to a speech recognition engine over the network, and receives a text transcription. The terminal may execute a camera application that captures facial images of the user and forwards frames to an emotion estimation engine. The terminal transmits the resulting text and optional audio or image features to the server using a structured communication protocol.

The server receives the text of the information request and performs natural-language processing. The server executes a tokenizer, a part-of-speech tagger, and a dependency parser to identify grammatical structure, named entities, time expressions, and domain-specific terms. The server then performs a mapping from extracted terms to candidate schema elements using the schema index. For example, when the user enters “last year's first quarter top sales product,” the server identifies “last year” as a temporal expression, resolves it to a calendar year value, identifies “first quarter” as a quarter constraint, and associates “sales” with a metric field in the sales table, and “product” with a product identifier or product name field.

The server estimates an emotional state of the user based on at least one of voice information, image information, and text information. In one embodiment, the server executes a convolutional neural network on facial image frames to compute an emotion classification vector over classes such as joy, anger, frustration, and neutral. The convolutional neural network may include multiple convolutional layers, pooling layers, and fully connected layers, trained using a cross-entropy loss function on labeled emotion datasets. In another embodiment, the server executes a recurrent neural network or a transformer-based model on acoustic features, such as Mel-frequency cepstral coefficients, energy, and pitch contours extracted from the user's speech, to estimate emotion. The server may further execute a text-based sentiment analysis model that uses a sequence-to-vector encoder with attention to map tokens of the user's text into an emotion vector. The server fuses these outputs using a weighted averaging or a small feed-forward neural network and obtains an overall emotional state, for example “joy” with an associated confidence score. This processing involves numerical operations such as matrix multiplication, non-linear activation, gradient-based weight adaptation during training, and softmax normalization during inference.

The server uses the learned schema and the parsed information request to construct a prompt sentence for the generative AI model. The server composes the prompt sentence by inserting explicit schema information, including table names, field names, and data types, into a textual instruction. The server further inserts constraints derived from the user query, such as time ranges, ranking criteria, grouping operations, and limit counts. The server optionally inserts the estimated emotional state, and instructions on how to adjust query complexity and priority according to emotion.

For example, the server may generate a prompt sentence as follows:

Convert the following question to SQL: “Tell me the top-selling products in the first quarter of last year.”

In another example, when the user is in a positive emotional state and requests an overview, the server may generate the prompt sentence:

User emotion: joy.

Database schema: sales(year, month, quarter, product_name, sales).

User question: “I want to see this month's sales data.”

Generate an SQL query that retrieves this month's sales grouped by category, ordered by total sales in descending order. Output only the SQL.

In yet another example, when the user is frustrated and requests a very specific piece of information, the server may generate the prompt sentence:

The user emotion is “frustration”. Generate an SQL query that quickly returns last year's Q1 sales for Product A with minimal columns.

Database schema: sales(year, quarter, product_name, sales).

User question: “I want to know the sales of Product A for the first quarter of last year.”

Output only the SQL.

The server passes the prompt sentence to the generative AI model. In one embodiment, the generative AI model is a transformer-based neural network trained on large corpora of text and code. The model includes a stack of self-attention layers, each having multiple attention heads, feed-forward sublayers, and layer normalization. The model is trained using a next-token prediction objective with a cross-entropy loss function and optimized by stochastic gradient descent or a variant thereof. During training, the model receives prompt sequences that include natural-language questions and corresponding query language statements. The model learns statistical patterns that map question structure, schema hints, and instructions to appropriate query language fragments.

The server invokes the generative AI model in inference mode. The server encodes the prompt sentence as a sequence of tokens, feeds the tokens to the transformer network, and obtains probability distributions over next tokens. The server generates the query language string by selecting tokens sequentially according to the output probabilities, optionally using decoding strategies such as greedy decoding or top-k sampling with a low temperature to favor deterministic outputs. This processing is performed inside the server or a dedicated accelerator device and involves vectorized linear algebra operations that are significantly faster and more consistent than attempts by human operators to manually write queries based on complicated schemas.

The server validates the generated query language against the learned schema. The server parses the query language using a query parser module, extracts referenced tables and fields, and checks that each referenced element exists in the schema graph. The server rejects or corrects any reference that does not match known tables or fields. The server enforces policies to restrict operations to safe operations, for example only permitting select operations and denying destructive operations. The server may rewrite the query language to align with canonical table or column naming conventions and to add missing conditions, such as non-null constraints or necessary joins. This validation step reduces erroneous database access and contributes to improved reliability and reduced computational waste caused by repeated query failures.

The server adjusts the content and complexity of the query language according to the estimated emotional state. When the user appears frustrated or impatient, the server reduces the number of retrieved fields and may add a limit clause to the query, so that the database only returns the most relevant rows. When the user appears joyful or exploratory, the server may add grouping clauses, additional computed measures, or sorting by multiple keys to present richer information. The server also adjusts an internal processing priority, for example assigning high-priority queue positions to urgent requests. As a result, the server routes high-priority queries to faster resources and executes them earlier, effectively reducing latency for emotionally sensitive scenarios. This priority mechanism improves utilization of computing resources and network bandwidth by aligning computation intensity and scheduling with user state.

The server executes the validated query language against the database. The database engine receives the query language string, parses it, and constructs an execution plan. The engine then accesses physical pages on disk or solid-state media, reads index structures, and performs join, aggregation, and sorting operations as specified. The engine outputs result records to the server. The server converts the result records into a format suitable for presentation. The server may perform additional computations on the results, such as computing percentages, ranking scores, or projections for visualization. These computations use numeric algorithms and data structures implemented inside the server's memory.

The server optionally uses the generative AI model a second time to produce a natural-language explanation of the result, based on the original question and the structured result. For example, the server may construct a prompt sentence as follows:

User question: “Please tell me the top-selling product in the first quarter of last year.”

SQL result: product_name=“Product A”.

Generate a concise answer in English for the user.

The generative AI model receives this prompt sentence, and the server obtains an explanatory sentence such as “The top selling product in the first quarter of last year was Product A.” The server outputs this sentence to the terminal, together with structured values that may be rendered in charts or tables.

The terminal receives the output from the server and presents it to the user. The terminal renders text and numerical values on the display screen, or plays synthesized speech through the speaker. In an embodiment with smart glasses, the terminal overlays numerical information or icons near physical objects, such as products on store shelves, by combining the location of the product in the camera image with inventory information obtained via the server. In this way, the system directly controls the behavior of physical devices (for example, displays and speakers) based on the outcome of the server's technical processing.

The system thus improves computer technology in multiple ways. Because the server automatically learns the schema and constructs schema-aware prompt sentences, the generative AI model can generate more accurate query language expressions that match the actual data structure, reducing errors and retries compared to naïve natural-language query interfaces that do not use explicit schema information. Because the server validates generated queries structurally and semantically before execution, the system reduces invalid database accesses and prevents unnecessary disk I/O, which in turn reduces processing time and resource consumption.

Because the server estimates the user's emotional state and uses it to adjust query complexity, response priority, and presentation richness, the system achieves a dynamic trade-off between computational load and informativeness that is not achievable by manual query writing or static rule-based systems. For example, a simplified query with a strict limit clause reduces CPU, memory, and network usage during peak loads while still answering a frustrated user's focused question, thereby improving throughput and latency for multiple users concurrently. Conversely, a more elaborate query with aggregated views and recommendations is executed when the user's emotional state indicates a willingness to explore data, exploiting idle computational capacity without degrading responsiveness for critical queries.

The internal operation of the generative AI model and the emotion estimation models is not a mere automation of a human mental process but leverages high-dimensional numerical representations, attention-based architectures, and gradient-based optimization that are specifically tailored to exploit hardware parallelism. The use of vectorized matrix multiplications and parallel attention mechanisms improves inference speed and scalability over rule-based or hand-coded query templates. The schema index and the validation logic implement a non-conventional pipeline whereby the server first converts natural-language to an intermediate intent structure, then to a schema-constrained prompt sentence, and then to a query language string that is filtered and possibly rewritten according to machine-enforced invariants. This multi-stage, machine-optimized pipeline constitutes a technical improvement over direct, unvalidated query generation.

In alternative embodiments, the server may use different generative AI model architectures, such as encoder-decoder transformers specialized for code generation, or mixture-of-experts models that route certain prompts to sub-models trained on particular domains. The server may also use alternative emotion estimation architectures, such as graph neural networks on facial landmarks, or convolutional recurrent networks that jointly model audio and video. The server may store the learned schema in various data structures, including key-value stores or graph databases, and may use different optimization strategies for prompt generation, such as precomputing template fragments for common query patterns and selecting appropriate fragments based on intent classification.

In another embodiment, the server may be implemented on a distributed cluster, and the generative AI model may be executed on dedicated accelerator hardware such as graphics processing units or tensor processing units. The server partitions query generation, schema learning, and emotion estimation across multiple nodes to achieve greater throughput. The terminal may be a desktop computer, a tablet, a wearable device, or an embedded device integrated into industrial equipment. The basic operations of schema analysis, prompt construction, emotion-adaptive query generation, validation, execution, and presentation remain as described, and provide similar technical effects in each configuration.

In still another embodiment, the server may use the same framework to control not only data retrieval but also selection of computational paths or algorithms within other processing modules. For example, depending on the estimated emotional state and query complexity, the server may choose between different query execution plans, different caching strategies, or different compression levels for transmitting results to the terminal. This further improves response latency and network usage, especially in constrained environments.

Thus, by structurally learning the underlying data schema, by constructing and supplying schema-embedded prompt sentences to a generative AI model, by validating and adjusting the generated query language based on both structural constraints and user emotion, and by integrating these components into a coherent hardware-software architecture, the server, the terminal, and the user cooperate to realize a system that provides improved accuracy, robustness, and computational efficiency for natural-language driven data access, beyond mere automation of human mental steps or abstract organization of human activity.

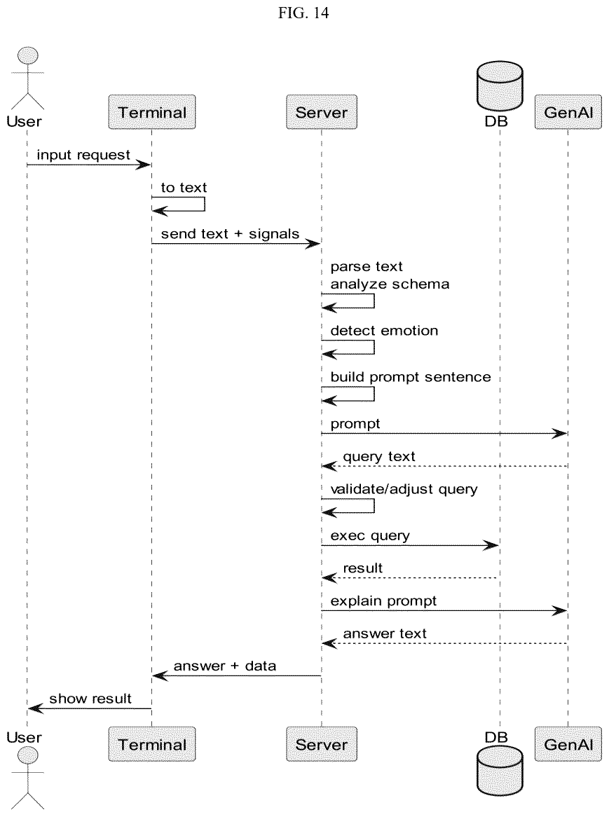

The following describes the processing flow using FIG. 14.

### Step 1

User provides an information request.

User inputs an information request through a terminal using text or speech. The input is a natural-language sentence such as “Tell me the top selling product this month” or “Please tell me the top-selling product from the first quarter of last year.” he output of this step is raw input data in human language form (keystrokes or speech audio) that will be processed by the terminal.

### Step 2

Terminal converts the user input into text.

Terminal receives the raw input from the user. For text input, the input is key events from a keyboard or touch panel; for speech input, the input is an audio signal captured by a microphone. Terminal applies a text input handler or a speech recognition client to convert the low-level input into a UTF-8 text string. Terminal, in the case of speech, sends the audio waveform to a speech recognition service and receives a transcription. The output of this step is a structured text string representing the user's information request, for example “Please tell me the top-selling product from the first quarter of last year.”

### Step 3

Terminal acquires emotion-related data.

Terminal receives as input sensor data such as video frames from a camera and audio features from a microphone, synchronized with the user's request. Terminal applies local pre-processing, such as resizing video frames and extracting basic acoustic features (energy, pitch), and then sends this processed data to an emotion estimation service if used on the terminal side, or directly forwards it to the server. The output of this step is emotion-related data, such as image frames, audio feature vectors, or preliminary emotion labels, packaged together with the text request.

### Step 4

Terminal transmits the request data to the server.

Terminal takes as input the text request and the emotion-related data from the previous steps. Terminal encapsulates this information into a structured message conforming to an application protocol, for example a JSON-like payload or a binary protocol, and sends it over a network connection to the server via HTTP or another communication protocol. The output of this step is a network message that arrives at the server containing at least the user's text request and optionally emotion-related features or labels.

### Step 5

Server receives and logs the request.

Server receives the network message as input. Server parses the message to extract the text of the information request, user identifiers, session identifiers, and any emotion-related data or preliminary emotion labels. Server performs data processing by writing these values into a log store or database for later analysis, associating timestamps and request identifiers. The output of this step is an internal request context object containing the parsed text request and associated metadata, stored in memory.

### Step 6

Server loads or updates the learned data structure.

Server uses as input the configuration for connecting to the data storage device and the current schema cache. Server queries the database metadata, if necessary, using schema introspection commands and receives table definitions, column names, data types, and relationships. Server processes this metadata by constructing or updating an internal schema graph and a schema index that maps textual labels to schema elements. The output of this step is an updated schema representation in server memory that will be used to interpret the user's request and to build schema-aware prompt sentences.

### Step 7

Server parses the natural-language request.

Server receives the user's text request and the schema representation as input. Server applies natural-language processing, including tokenization, part-of-speech tagging, named entity recognition, and dependency parsing, to extract syntactic and semantic structure. Server then performs data processing to map key terms and phrases to schema elements using similarity computations between token embeddings and schema element embeddings. The output of this step is an intent structure containing elements such as target tables, fields, time constraints (for example year and quarter), aggregation type (for example top product by sales), and filters.

### Step 8

Server estimates the user's emotional state.

Server uses as input the emotion-related data received from the terminal (for example image frames, audio features, or text) and the metadata from the request. Server feeds this data into one or more emotion estimation models, such as a convolutional neural network for images, a recurrent or transformer-based model for audio, or a sentiment classifier for text. Server performs numerical operations such as matrix multiplications and non-linear activations to generate class probabilities or continuous scores for emotion categories. The output of this step is an estimated emotional state label (for example “joy”, “anger”, “frustration”, “neutral”) and an associated confidence or score vector stored in the request context.

### Step 9

Server determines query style and priority from emotion.

Server receives as input the estimated emotional state and the intent structure. Server executes rule-based logic or a small decision model that maps emotion labels to processing parameters, such as query complexity mode (“minimal_fast” vs. “exploratory_rich”) and scheduling priority (“high” vs. “normal”). Server performs data processing by assigning these parameters to fields in the request context. The output of this step is an enriched request context that specifies how complex the forthcoming query should be and how urgent its execution is.

### Step 10

Server constructs a schema-aware prompt sentence.

Server takes as input the intent structure, the schema representation, and the query style parameters. Server selects relevant table names, field names, and data types from the schema, and combines them with the user's natural-language question and instructions that specify desired query behavior. Server then concatenates these textual elements into a single prompt sentence that instructs the generative AI model to generate a particular kind of query. For example, server may generate the following prompt sentence:

Convert the following question to SQL: “Please tell me the top-selling product from the first quarter of last year.”

or

User emotion: joy.

Database schema: sales(year, month, quarter, product_name, sales).

User question: “I want to see this month's sales data.”

Generate an SQL query that retrieves this month's sales grouped by category, ordered by total sales in descending order. Output only the SQL.

The output of this step is a text string representing the prompt sentence that encodes schema, user intent, and emotion-aware instructions.

### Step 11

Server sends the prompt sentence to the generative AI model.

Server uses the prompt sentence as input and passes it to the generative AI model through an inference interface. Server converts the prompt sentence into token IDs and feeds them into the transformer-based network. The generative AI model performs internal computations over multiple attention layers to predict a sequence of output tokens representing the query language statement. Server decodes the tokens back into a text string. The output of this step is a candidate query language string, for example an SQL query that matches the user's request and the schema constraints.

### Step 12

Server validates and adjusts the generated query language.

Server receives as input the candidate query language string and the learned schema representation, along with the query style parameters. Server parses the candidate query language using a query parser to extract referenced tables, fields, and operations. Server performs data processing by checking each referenced element against the schema graph to ensure it exists and by confirming that only permitted operations are present. Server also adjusts the query according to the style parameters, for example adding a LIMIT clause for a “minimal_fast” style or additional GROUP BY clauses for an “exploratory_rich” style. The output of this step is a validated and, if necessary, rewritten query language string that is guaranteed to be structurally consistent with the data structure and aligned with emotion-based policies.

### Step 13

Server schedules and executes the query on the database.

Server takes as input the validated query language string and the processing priority parameter. Server enqueues the query execution task in a scheduler that assigns higher priority tasks to faster or less loaded execution threads. When a worker thread picks up the task, the server sends the query language to the database engine using a database driver. The database engine processes the query, performs index lookups, joins, aggregations, and sorting, and returns result rows. The output of this step is a dataset, such as a list of records containing fields like product_name and sales, available in server memory.

### Step 14

Server post-processes the query results.

Server uses as input the dataset returned from the database and the intent structure. Server performs data processing such as filtering non-essential fields, computing derived metrics (for example percentages or rankings), and structuring the data into a format suitable for visualization or for text explanation. Server may also decide whether to call the generative AI model again to generate a natural-language explanation. The output of this step is a structured result object that includes cleaned numerical data and optional explanatory text or that is ready for explanation generation.

### Step 15

Server optionally generates a natural-language answer.

Server takes as input the original user question and the structured result object. Server constructs a secondary prompt sentence that includes the question and summarized result values, for example:

User question: “Please tell me the top-selling product from the first quarter of last year.”

SQL result: product_name=“Product A”.

Generate a concise answer in English for the user.

Server sends this prompt sentence to the generative AI model, which generates an answer sentence. Server decodes the output tokens into a natural-language text string. The output of this step is an answer text, such as “The top selling product in the first quarter of last year was Product A.”

### Step 16

Server packages the response and sends it to the terminal.

Server receives as input the structured result object and any generated natural-language answer. Server assembles a response payload containing fields such as the answer text, numerical data, and any priority or emotion-related flags that may affect display. Server serializes this payload into a response message and transmits it over the network to the terminal using the established communication protocol. The output of this step is a network response message that carries the computed results to the terminal.

### Step 17

Terminal presents the result to the user.

Terminal takes as input the response message from the server. Terminal deserializes the message to obtain the answer text and numerical data. Terminal performs data processing such as mapping the data to chart widgets, tables, or overlay indicators on a display. Terminal may also convert the answer text into synthesized speech and play it through a speaker. The output of this step is a visual and/or audio presentation that the user perceives, such as a displayed sentence “The top selling product in the first quarter of last year was Product A.” and a chart of top products.

### Step 18

User reviews the result and optionally issues a follow-up request.

User observes the displayed or spoken information as input. Based on this information, user may formulate a new, refined, or follow-up question, such as “Show me the category breakdown for that quarter,” and enters or speaks the new request into the terminal. The output of this step is a new natural-language request, which again becomes the input to Step 1, thereby repeating the processing cycle with updated context and potentially a different emotional state.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

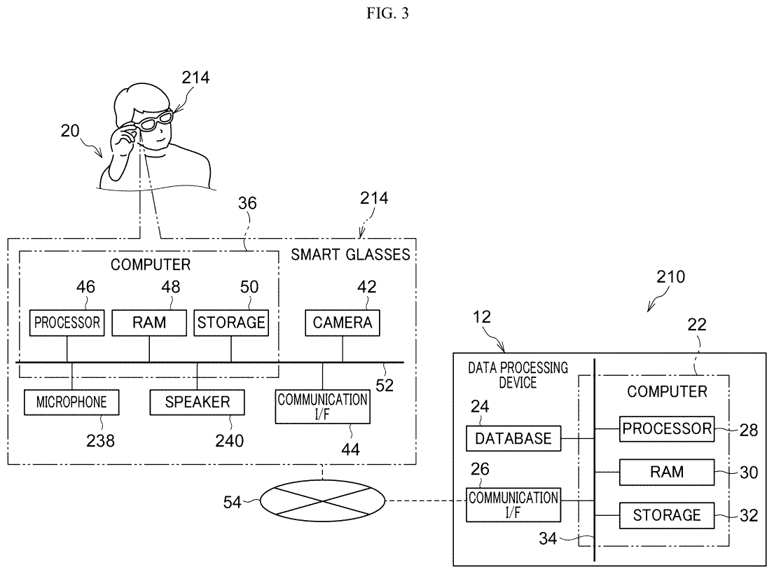

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

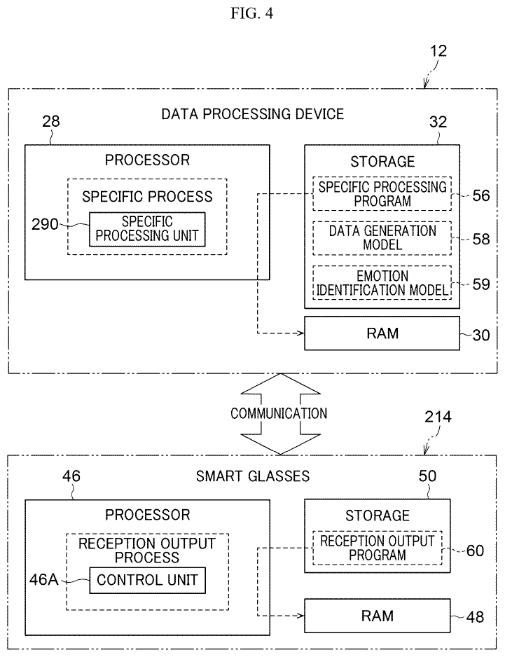

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

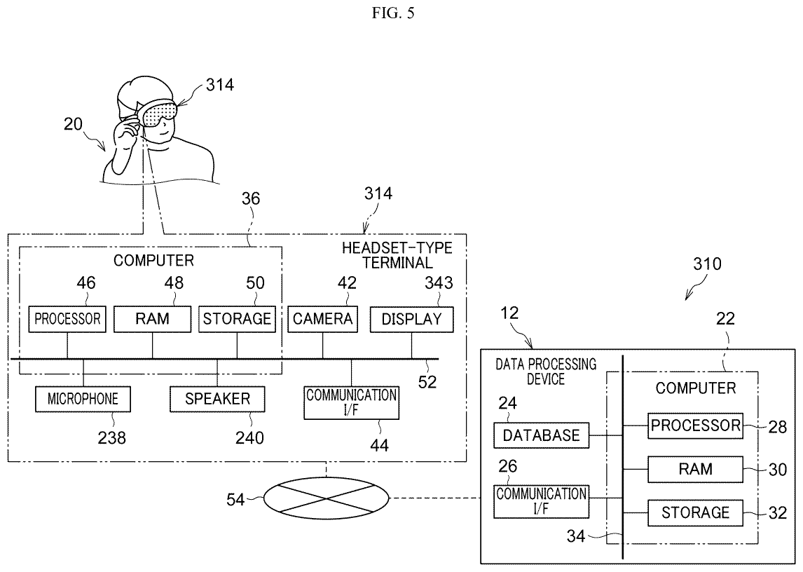

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

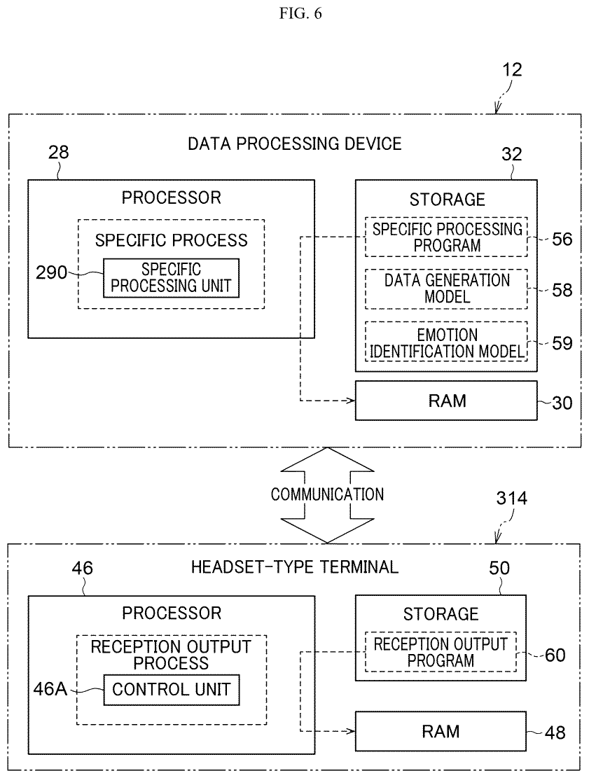

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

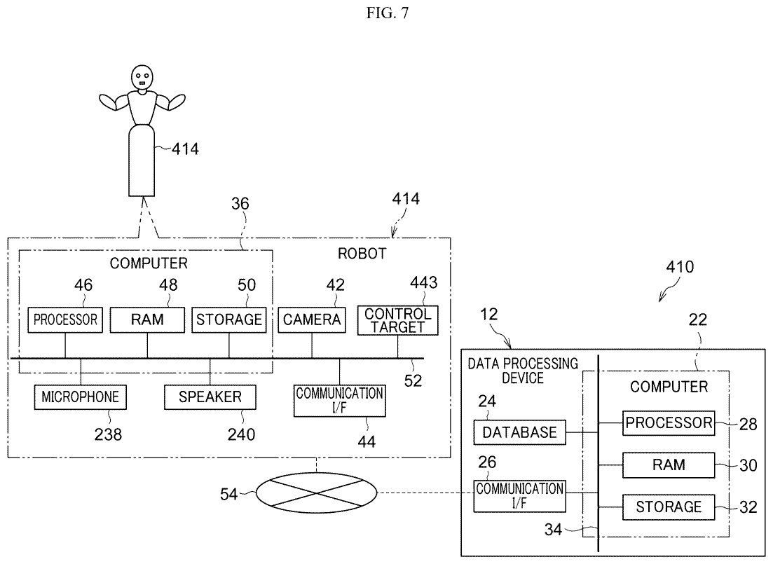

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

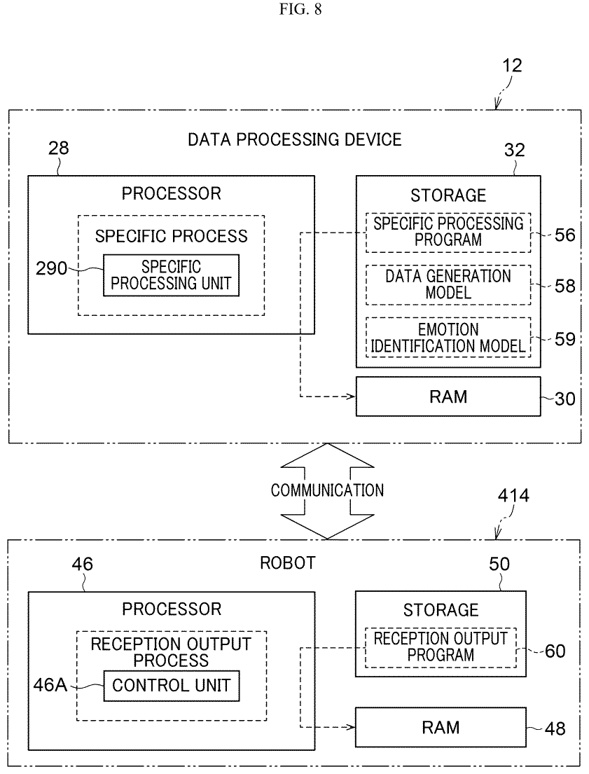

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

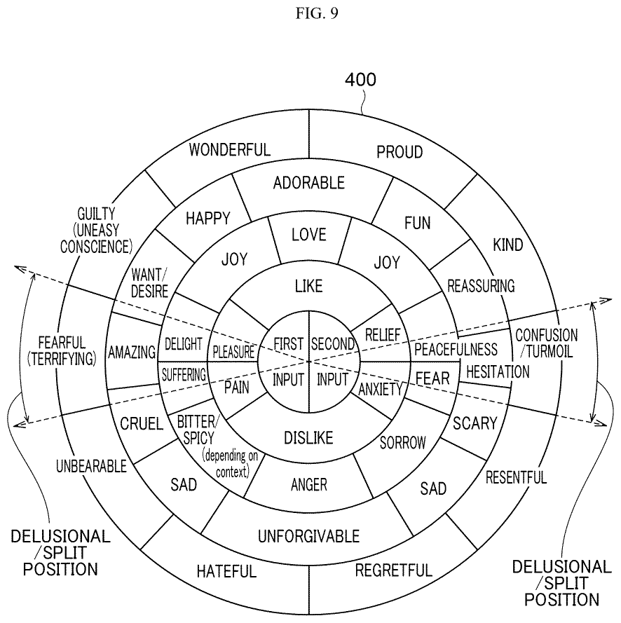

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

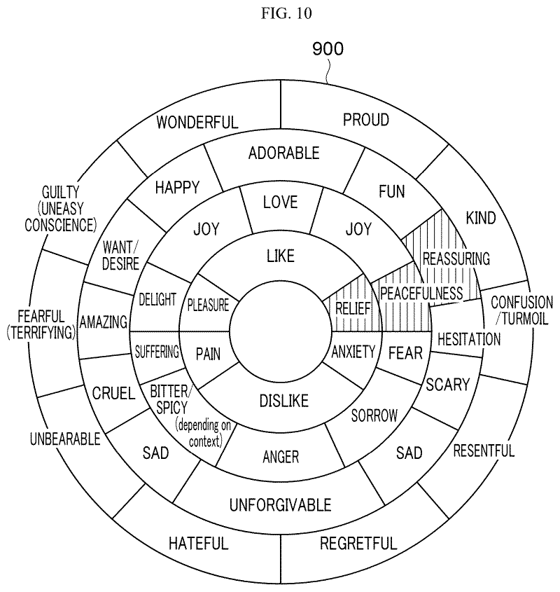

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire attribute information related to a structure of structured information stored in an information processing apparatus, analyze a logical structure and relationships between items of the structured information based on the attribute information, and store an analysis result as a learning result,
receive, in a natural language format via a communication line from a terminal device, an information acquisition request of a user and extract an intention and a condition of the information acquisition request,
generate a prompt sentence to be input to a generative artificial intelligence model based on the learning result and the extracted intention and condition, and instruct the generative artificial intelligence model to generate a query formal language by using the prompt sentence,
obtain the query formal language output from the generative artificial intelligence model, inspect whether a referenced information structure and item name in the query formal language conform to the structure of the structured information, and, when the query formal language is nonconforming, correct the query formal language automatically by modifying the prompt sentence and instructing the generative artificial intelligence model to regenerate the query formal language, and
execute a query process on the information processing apparatus by using the corrected query formal language, process information acquired by the query process into output information by aggregation processing or formatting processing, and transmit the output information to the terminal device.

### Supplementary 2

The System According to Supplementary 1,
wherein the processor is configured to cause the terminal device to visualize the output information in a tabular format or a chart format, and, when an additional information acquisition request in a natural language is received from the user via the terminal device, to receive the additional information acquisition request from the terminal device and repeatedly execute a generation process of the query formal language and the query process.

### Supplementary 3

The system according to supplementary 1,
wherein the processor is configured to, when generating the prompt sentence to be input to the generative artificial intelligence model, select attribute information corresponding to all or a part of the structure of the structured information and include the selected attribute information in the prompt sentence, thereby controlling an information range to be a generation target of the query formal language.

### Application Example 1

### Supplementary 1

A system comprising a processor,
wherein the processor is configured to
analyze an information structure of a data storage device including an attribute set and a relation set, and learn the information structure,
receive, from a user information processing apparatus via a communication line, a prompt sentence including an information request in natural language and acquire identification information and environment information associated with the prompt sentence,
preprocess the prompt sentence by performing character string normalization, phrase segmentation, and code sequence conversion to generate an input data sequence for a generative AI model,
execute inference processing on the input data sequence by using the generative AI model to generate an intermediate representation including a target data set, a condition set, a join set, an aggregation set, and a classification set,
automatically generate a query command set in a query language based on the intermediate representation and the information structure, transmit the query command set to the data storage device, and acquire information from the data storage device,
perform aggregation processing and formatting processing on the acquired information to generate a display data set, and
generate visualization information including graphical elements based on the display data set and transmit the visualization information as image data or structured data to the user information processing apparatus.

### Supplementary 2

The system according to supplementary 1,
wherein the processor is configured to
selectively analyze and learn all or part of the information structure of the data storage device and dynamically switch a table set and an attribute set to be analyzed.

### Supplementary 3

The system according to supplementary 1,
wherein the processor is configured to
analyze the information request from the user, construct the prompt sentence for instructing generation of the query language by the generative AI model, and convert the prompt sentence into a format compatible with an input format of the generative AI model.

### Example 2

### Supplementary 1

A system comprising a processor,
wherein the processor is configured to
analyze a tabular structure of a data storage apparatus to acquire attribute information regarding the tabular structure and to learn the tabular structure based on the attribute information,
receive, from a terminal operated by an information requester, an information request expressed in a natural language or in a predetermined format, and construct a prompt sentence based on content of the information request and the attribute information so as to instruct a generative information processing model to generate a query language,
input the prompt sentence to the generative information processing model, obtain, from the generative information processing model, a query language output, perform a safety check on the query language based on allowed expressions and constraints on referenced objects, and transmit the query language to the data storage apparatus for execution so as to obtain numerical information or item information as an execution result, and
convert the obtained numerical information or item information into an internal data structure, generate a natural-language response sentence based on the internal data structure, and transmit the response sentence to the terminal for display.

### Supplementary 2

The system according to supplementary 1,
wherein the processor is configured to
selectively analyze all or part of the tabular structure of the data storage apparatus and learn only attribute information corresponding to items related to the information request in the tabular structure.

### Supplementary 3

The system according to supplementary 1,
wherein the processor is configured to
analyze the information request expressed in the natural language from the information requester, extract a target item, a target period, and a calculation type from the information request, and embed an extraction result into the prompt sentence in association with the attribute information of the tabular structure so as to generate the prompt sentence for instructing the generative information processing model to generate the query language.

### Application Example 2

### Supplementary 1

A system comprising a processor,
wherein the processor is configured to analyze a data structure stored in a storage device connected to an information processing apparatus and learn the data structure,
receive, from a user via an input terminal, an information request expressed in natural language, and generate a prompt sentence that instructs a generative artificial intelligence model to generate a query language based on a content of the information request and the data structure, estimate an emotional state of the user based on at least one of voice information, image information, and text information of the user, and adjust at least one of a content of the prompt sentence, a content of the query language, and a processing priority of the information request in accordance with the emotional state,
input the prompt sentence to the generative artificial intelligence model so as to automatically generate the query language, and acquire desired information from the storage device based on the query language, and
present the acquired information to the user via a visual display device or an audio output device.

### Supplementary 2

The system according to supplementary 1,
wherein the processor is configured to change at least a part of retrieval items, aggregation conditions, or sorting conditions included in the query language based on the emotional state, and to adjust the query language so as to preferentially acquire information in accordance with a degree of interest or dissatisfaction of the user.

### Supplementary 3

The system according to supplementary 1,
wherein the processor is configured to add schema information including at least a part of table names, item names, and data types included in the data structure to the prompt sentence by embedding the schema information in the prompt sentence, so as to improve generation accuracy of the query language by the generative artificial intelligence model.

What is claimed is:

1. A system comprising:
a communication interface coupled to a packet-switched network;
a storage device; and
circuitry configured to:
acquire attribute information related to a structure of structured information stored in an information processing apparatus, analyze a logical structure and relationships between items of the structured information based on the attribute information, and store an analysis result as a learning result in the storage device;
receive, via the communication interface, an information acquisition request expressed in a natural language from a terminal device, and extract an intention and a condition from the information acquisition request;
generate, based on the learning result and the extracted intention and condition, a schema-aware prompt sentence for a generative neural network model, and input the prompt sentence to the generative neural network model to acquire a query formal language expression;
inspect whether a referenced information structure and item name in the query formal language expression conform to the structure of the structured information, and, when nonconforming, modify the prompt sentence and instruct the generative neural network model to regenerate the query formal language expression; and
execute a query process on the information processing apparatus using the query formal language expression, process acquired information into output information by at least one of aggregation processing and formatting processing, and transmit the output information to the terminal device via the communication interface.

2. The system according to claim 1, wherein the circuitry is further configured to:
cause the terminal device to render the output information in at least one of a tabular format and a chart format, and, upon receiving an additional information acquisition request in a natural language from the terminal device, repeatedly execute the generation of the query formal language expression and the query process.

3. The system according to claim 2, wherein the circuitry maintains a session context comprising the prior information acquisition request, the prior query formal language expression, and the prior output information, and includes the session context in a subsequent prompt sentence to enable iterative refinement of the query.

4. The system according to claim 1, wherein the circuitry is further configured to:
select, when generating the schema-aware prompt sentence, attribute information corresponding to a subset of the structure of the structured information relevant to the extracted intention, and include the selected attribute information in the prompt sentence to constrain an information range of the query formal language expression.

5. The system according to claim 4, wherein the circuitry constructs a logical structure graph in which nodes represent tables or items and edges represent relationships, and traverses the logical structure graph to identify the subset of the structure relevant to the extracted intention.

6. The system according to claim 5, wherein the circuitry computes statistical descriptors for each item including value distributions and cardinality estimates, and includes the statistical descriptors in the prompt sentence as additional constraints for the generative neural network model.

7. The system according to claim 1, wherein the circuitry is further configured to:
preprocess the information acquisition request by performing character string normalization, phrase segmentation, and code sequence conversion to generate an input data sequence, and input the input data sequence to the generative neural network model.

8. The system according to claim 7, wherein the generative neural network model generates an intermediate representation comprising a target data set, a condition set, a join set, an aggregation set, and a classification set, and the circuitry converts the intermediate representation into the query formal language expression.

9. The system according to claim 8, wherein the circuitry validates the intermediate representation by verifying that referenced tables and attributes in the intermediate representation exist in the learning result, and applies rule-based disambiguation using the relationship data in the learning result when the intermediate representation includes an ambiguous reference.

10. The system according to claim 1, wherein the circuitry performs the inspection by parsing the query formal language expression into an abstract syntax tree, comparing table names and item names in the abstract syntax tree with the learning result, and rejecting the query formal language expression when a disallowed operation is detected.

11. The system according to claim 10, wherein the circuitry, upon rejecting the query formal language expression, generates a corrective prompt sentence that includes an error description identifying the nonconforming element and a listing of valid alternatives, and resubmits the corrective prompt sentence to the generative neural network model.

12. The system according to claim 11, wherein the circuitry limits a number of regeneration iterations to a predetermined maximum and, upon reaching the maximum, generates a fallback query using a deterministic template derived from the learning result and the extracted intention.

13. The system according to claim 1, wherein the circuitry is further configured to:
generate visualization information comprising graphical elements based on the output information, select a visualization type based on a structure of the output information, and transmit the visualization information as at least one of image data and structured rendering data to the terminal device via the communication interface.

14. The system according to claim 1, wherein the circuitry is further configured to:
estimate an emotional state of the user based on at least one of voice information, image information, and text information received from the terminal device, and adjust at least one of a content of the prompt sentence and a processing priority of the information acquisition request based on the emotional state.

15. The system according to claim 14, wherein the circuitry adjusts a complexity of the query formal language expression based on the emotional state by modifying at least one of a number of retrieval items, aggregation conditions, and a row limit parameter included in the query formal language expression.

16. The system according to claim 1, wherein the circuitry is further configured to:
train an anomaly detection model on historical query execution data representing normal execution patterns, compute a reconstruction error for a newly generated query formal language expression using the anomaly detection model, and flag the query formal language expression for manual review when the reconstruction error exceeds a predetermined threshold.

17. The system according to claim 1, wherein the circuitry generates the schema-aware prompt sentence by embedding, in the prompt sentence, schema information comprising table names, item names, data types, and index usage hints derived from the learning result, the index usage hints instructing the generative neural network model to generate the query formal language expression aligned with indexed access paths.

18. A system comprising:
a communication interface coupled to a packet-switched network;
a storage device; and
circuitry configured to:
acquire attribute information from an information processing apparatus, analyze a logical structure and relationships between items of structured information based on the attribute information, construct a logical structure graph, and store the logical structure graph in the storage device as a learning result;
receive, via the communication interface, an information acquisition request in a natural language from a terminal device, extract an intention, a condition, and a target item from the information acquisition request using natural language processing and similarity computation against the learning result;
generate a schema-aware prompt sentence for a generative neural network model by embedding relevant attribute information, the extracted intention, the condition, and the target item, input the prompt sentence to the generative neural network model, and acquire a query formal language expression;
inspect the query formal language expression against the learning result, and, when nonconforming, modify the prompt sentence with a corrective instruction and instruct the generative neural network model to regenerate the query formal language expression;
execute the query formal language expression on the information processing apparatus, perform aggregation processing and formatting processing on acquired information to generate a display data set, and generate visualization information comprising graphical elements based on the display data set; and
transmit, via the communication interface, the visualization information and the display data set to the terminal device.

19. The system according to claim 18, wherein the circuitry estimates an emotional state of a user based on at least one of voice information, image information, and text information, and adjusts at least one of a complexity of the query formal language expression and a processing priority based on the emotional state.

20. A method comprising:
acquiring attribute information related to a structure of structured information stored in an information processing apparatus, analyzing a logical structure and relationships between items of the structured information based on the attribute information, and storing an analysis result as a learning result in a storage device;
receiving, via a communication interface coupled to a packet-switched network, an information acquisition request expressed in a natural language from a terminal device, and extracting an intention and a condition from the information acquisition request;
generating, based on the learning result and the extracted intention and condition, a schema-aware prompt sentence for a generative neural network model, and inputting the prompt sentence to the generative neural network model to acquire a query formal language expression;
inspecting whether a referenced information structure and item name in the query formal language expression conform to the structure of the structured information, and, when nonconforming, modifying the prompt sentence and instructing the generative neural network model to regenerate the query formal language expression; and
executing a query process on the information processing apparatus using the query formal language expression, processing acquired information into output information by at least one of aggregation processing and formatting processing, and transmitting the output information to the terminal device via the communication interface.
